(19) United States
(12) Patent Application Publication
(10) Pub. No.: US 2026/0181649 A1
(43) Pub. Date: Jun. 25, 2026

(54) Managing Master Node Communication in Conditional Dual Connectivity

(71) Applicant: GOOGLE LLC, Mountain View, CA (US)

(72) Inventors: Chih-Hsiang Wu, Taoyuan City (TW); Ching-Jung Hsieh, Taoyuan City (TW)

(21) Appl. No.: 19/124,780

(22) PCT Filed: Oct. 30, 2023
(86) PCT No.: PCT/US2023/036318

§ 371 Date: Apr. 25, 2025

Related U.S. Application Data
(60) Provisional application No. 63/420,583, filed on Oct. 29, 2022.
(60) Provisional application No. 63/383,916, filed on Nov. 15, 2022.

(51) Int. Cl. H04W 72/23

(52) U.S. Cl. CPC H04W 72/23

(57) ABSTRACT

A central unit (CU) of a distributed base station that also includes a distributed unit (DU) transmits (1402), to the DU, a context modification request for a UE, the context modification request including (i) a first indication that the context modification request pertains to a conditional addition or change of a primary secondary cell (PSCell), and (ii) a second indication of whether a preparation for the conditional addition or change has been executed; and receives (1408), from the DU, a context modification response for the UE.

### CROSS-REFERENCE TO RELATED APPLICATIONS

This application claims priority to and the benefit of the filing date of provisional U.S. Patent Application No. 63/420,583 entitled “Managing Master Node Communication in Conditional Dual Connectivity,” filed on Oct. 29, 2022 and provisional U.S. Patent Application No. 63/383,916 entitled “Managing Master Node Communication in Conditional Dual Connectivity,” filed on Nov. 15, 2022. The entire contents of these provisional applications are hereby expressly incorporated herein by reference.

### FIELD OF THE DISCLOSURE

This disclosure relates generally to wireless communications and, more particularly, to managing master node communication in dual connectivity for conditional configurations for multi-connectivity such as secondary node addition or change procedures.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, a user equipment (UE) sometimes can concurrently utilize resources of multiple radio access network (RAN) nodes, such as base stations or components of a disaggregated base station (also referred to as a distributed base station), interconnected by a backhaul. When these network nodes support different radio access technologies (RATs), this type of connectivity is referred to as Multi-Radio Dual Connectivity (MR-DC). When a UE operates in MR-DC, one base station operates as a master node (MN) that covers a primary cell (PCell), and the other base station operates as a secondary node (SN) that covers a primary secondary cell (PSCell). The UE communicates with the MN (via the PCell) and the SN (via the PSCell). In other scenarios, the UE transfers a wireless connection from one base station to another base station. For example, a serving base station can determine to hand the UE over to a target base station and initiate a handover procedure.

3GPP specification TS 37.340 v16.6.0 describes procedures for a UE to add or change an SN in DC scenarios. These procedures involve messaging (e.g., RRC signaling and preparation) between radio access network (RAN) nodes. This messaging generally causes latency, which in turn increases the probability that the SN addition or SN change procedure will fail. These legacy procedures, which do not involve conditions that are checked at the UE, can be referred to as “immediate” SN addition and SN change procedures.

More recently, for both SN or PSCell addition/change, “conditional” procedures have been considered (i.e., conditional SN or PSCell addition/change). Unlike the “immediate” procedures discussed above, these procedures do not add or change the SN or PSCell, or perform the handover, until the UE determines that a condition is satisfied. As used herein, the term “condition” may refer to a single, detectable state or event (e.g., a particular signal quality metric exceeding a threshold), or to a logical combination of such states or events (e.g., “Condition A and Condition B,” or “(Condition A or Condition B) and Condition C”, etc.).

To configure a conditional procedure, the RAN provides the condition to the UE, along with a configuration (e.g., one or more random-access preambles, etc.) that will enable the UE to communicate with the appropriate base station, or via the appropriate cell, when the condition is satisfied. For a conditional addition of a base station as an SN or a candidate cell as a PSCell, for example, the RAN provides the UE with a condition to be satisfied before the UE can add that base station as the SN or that candidate cell as the PSCell, and a configuration that enables the UE to communicate with that base station or PSCell after the condition has been satisfied.

As part of the immediate PSCell addition or change procedure, the RAN (i.e., MN or SN) transmits an RRC reconfiguration message including multiple configuration parameters to the UE and the UE attempts to connect to a (target) PSCell configured by the RRC reconfiguration message. After the UE successfully connects to the SN via the PSCell, the UE communicates with the SN on the PSCell by using the multiple configuration parameters and security key(s) associated to the PSCell and derived from one or more security configuration parameters in the RRC reconfiguration message. The SN also derives security key(s) which match the security key(s) derived from the UE. After the UE successfully connects to the PSCell, the RAN (e.g., the SN) communicates data with the UE by using the matching security key(s) and the multiple configuration parameters.

In some cases, a candidate SN (C-SN) can provide multiple candidate configurations when, for example, multiple candidate PSCells are available. When the MN completes the preparation for a conditional SN procedure (e.g., conditional SN addition or conditional SN cell change), the MN at this time cannot determine which candidate secondary cell the UE will connect to in the future. Moreover, because the UE connects to the secondary cell only subject to the fulfillment of one or more conditions, the MN cannot determine whether the UE will even connect to any of the candidate cells in the future.

Conditional SN procedures present certain challenges for coordinating usage of radio resources between an MN and an SN in a correct and timely manner. Coordination can involve selecting power or discontinuous reception (DRX) parameters at the MN in view of the SN, for example, or limiting uplink power of the UE when transmitting to the MN in view of any overlapping uplink transmission to the SN. Furthermore, when the MN includes a central unit (CU) and a distributed unit (DU), it is unknown how the CU controls the DU to select power or DRX parameters.

It is not yet clear how a distributed MN can generate a conditional RRC reconfiguration message including MCG configuration for CPAC, given that the MCG configuration is also conditional, and the candidate SN provides a CG-CandidateList information element (IE) rather than a single CG-Config IE to the MN when the network prepares multiple candidate PSCells. It also unclear how, upon CPAC execution, the MN-DU, such as gNB-DU, can determine that a UE selected a certain candidate PSCell, how the MN-DU can apply a corresponding MCG L1/L2 configuration. Still further, it is not clear how the MN-DU can obtain MN restriction information (e.g., powerCoordination-FR1, powerCoordination-FR2, or p-maxNR-FR1-MCG).

### SUMMARY

An example embodiment of the techniques of this disclosure is a configuration method implemented in a CU of a distributed base station that also includes a DU. The method comprises transmitting, to the DU, a context modification request for a UE, the context modification request including (i) a first indication that the context modification request pertains to a conditional addition or change of a primary secondary cell (PSCell), and (ii) a second indication of whether a preparation for the conditional addition or change has been executed; and receiving, from the DU, a context modification response for the UE.

Another example embodiment of these techniques is a configuration method implemented in a DU of a distributed base station that also includes a CU. The method comprises receiving, from the DU, a context modification request for a UE, the context modification request including a first indication that the context modification request pertains to a conditional addition or change of a primary secondary cell (PSCell); and determining, based on a second indication included in the context modification request, whether a preparation for conditional addition or change has been executed.

Yet another example embodiment of these techniques is a RAN node that comprise a transceiver and processing hardware configured to implement one of the methods above.

Another example embodiment of these techniques is a method for managing conditional cell change in a central unit (CU) of a distributed base station that includes the CU and a distributed unit (DU), the method comprising: obtaining, by the CU, a cell group (CG) configuration for one or more candidate secondary cells of a candidate secondary node (SN) to support dual connectivity (DC) between a UE, the DU operating as a master node (MN), and the candidate SN; transmitting, from the CU to the DU, the CG configuration; receiving, from at the CU from the DU, a DU configuration corresponding to the CG configuration; and transmitting. from the CU to the UE via the DU, (i) a conditional SN configuration corresponding to the CG configuration, (ii) at least one condition to be satisfied prior to the UE initiating a procedure to connect to the candidate node according to the conditional SN configuration, and (iii) the DU configuration.

Another example embodiment of these techniques is a base station comprising processing hardware and configured to implement the method above.

### BRIEF DESCRIPTION OF THE DRAWINGS

FIG. 1A is a block diagram of an example system in which a base station and/or a user equipment (UE) can implement the techniques of this disclosure for managing conditional procedures related to a master node (MN) or a secondary node (SN);

FIG. 1B is another block diagram of an example system in which a radio access network (RAN) and a user device can implement the techniques of this disclosure for managing conditional procedures related to an MN or an SN;

FIG. 1C is a block diagram of an example base station including a central unit (CU) and a distributed unit (DU) that can operate in the system of FIG. 1A or FIG. 1B;

FIG. 2A is a block diagram of an example protocol stack according to which the UE of FIGS. 1A-1B can communicate with base stations;

FIG. 2B is a block diagram of an example protocol stack according to which the UE of FIG. 1A can communicate with a DU and a CU of a base station;

FIG. 3A is a messaging diagram of an example scenario where an MN receives and processes one or more SN configurations from a C-SN during a Conditional SN Addition procedure;

FIG. 3B is a messaging diagram of an example scenario where an MN receives and processes one or more SN configurations from a C-SN during an MN-initiated Conditional SN Change procedure;

FIG. 3C is a messaging diagram of an example scenario where an MN receives and processes one or more SN configurations from a C-SN during an SN-initiated Conditional SN Change scenario;

FIG. 3D is a messaging diagram of an example scenario where a C-MN receives a conditional handover request and receives and processes one or more SN configurations from a C-SN during a Conditional Handover with CPAC scenario;

FIG. 3E is a messaging diagram of an example scenario where an C-MN receives a conditional handover request and receives and processes a SN configuration from a C-SN during a Conditional Handover with SCG configuration scenario;

FIG. 4 is a messaging diagram of an example scenario similar to the scenarios of FIGS. 3A-3C, except that a single base station operating as both the MN and the SN performs the Conditional SN Addition or Change procedure;

FIG. 5 is a flow diagram of an example method where a CU of an MN receives a conditional configuration during a conditional procedure with a C-SN and later transmits multi-connectivity coordination information to a DU;

FIG. 6 is a flow diagram of an example method similar to the method of FIG. 5, but where the CU receives multiple conditional configurations for multiple respective candidate cells of the C-SN and identifies which multi-connectivity coordination information to transmit to the DU based on to which candidate cell the UE has connected;

FIG. 7 is a flow diagram of an example method where a CU of MN that performs an SN procedure determines when to transmit multi-connectivity coordination information to a DU based on whether the SN procedure is a conditional SN procedure or an immediate SN procedure;

FIGS. 8-10 are similar to the methods of FIGS. 5-7, respectively, except where a single base station operates as the MN and the SN;

FIG. 11 is a flow diagram of an example method where a CU of C-MN notifies a DU of C-MN to perform a conditional preparation for handover and one or more conditional preparations for multi-connectivity coordination for a RAN node and later instructs the DU to apply the prepared handover and multi-connectivity coordination;

FIG. 12 is a flow diagram of an example method where a CU of C-MN notifies a DU of C-MN to perform a conditional preparation for handover and a conditional preparation for multi-connectivity coordination for a RAN node and later instructs the DU to apply the prepared handover and multi-connectivity coordination;

FIG. 13 is a flow diagram of an example method where a CU of C-MN notifies a DU of C-MN to perform a conditional preparation for handover and conditional preparation(s) for multi-connectivity coordination for a RAN node; and

FIG. 14 is a flow diagram of an example method for preparing one or more configurations for multi-connectivity coordination and applying one particular prepared configuration when being notified by a CU, which can be implemented in a DU.

### DETAILED DESCRIPTION OF THE DRAWINGS

As discussed in detail below, a UE and/or one or more base stations can use the techniques of this disclosure to manage conditional procedures, such as conditional PSCell addition or change (CPAC). This disclosure may also refer to a conditional PSCell addition procedure and a conditional PSCell change procedure separately using the acronyms CPA and CPC, respectively. Further, base stations can use the techniques of this disclosure to manage multi-connectivity coordination information to support multi-connectivity. This multi-connectivity coordination information may include parameters for the MN and SN to coordinate frequency bands, transmission timing, power control, signal directionality, and other wireless communication aspects. The multi-connectivity coordination information may additionally or alternatively include restriction information to, for example, limit maximum power levels for uplink power control at a connected RAN node.

A CU of a distributed base station obtains configuration information for one or more candidate secondary cells of a candidate SN, during a conditional procedure for adding or changing the SN. When the CU and the candidate SN are implemented in different base stations, the CU receives a message via an inter-base-station interface. When the CU and the candidate SN are implemented in the same base station (e.g., when the candidate node is another DU of the distributed base station), the CU can retrieve the configuration information directly from the memory. The CU obtains a DU configuration corresponding to the configuration information of the SN and then provides to the UE the SN configuration, the DU configuration, and the condition to be specified prior to the UE applying the SN configuration.

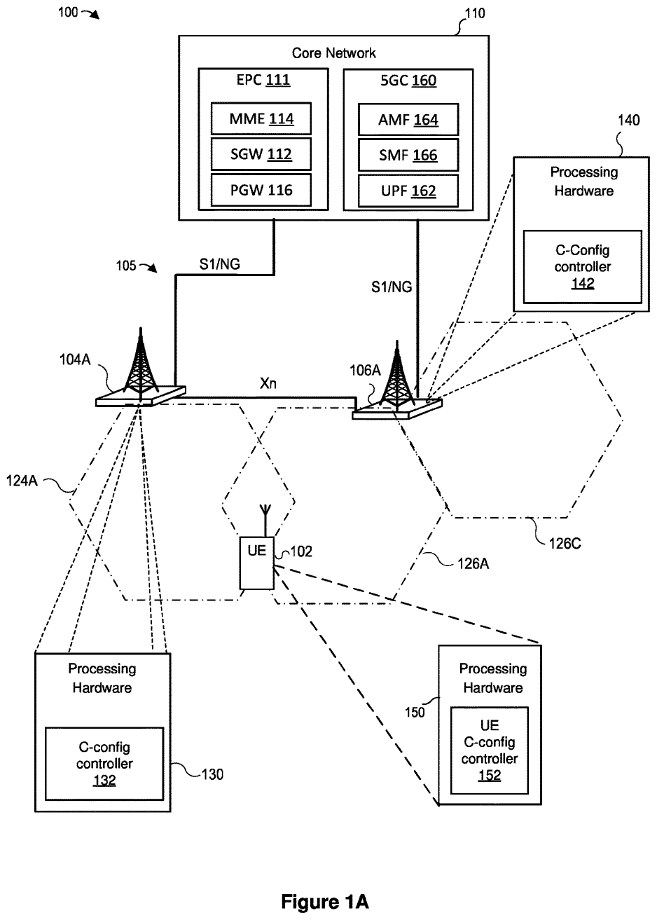

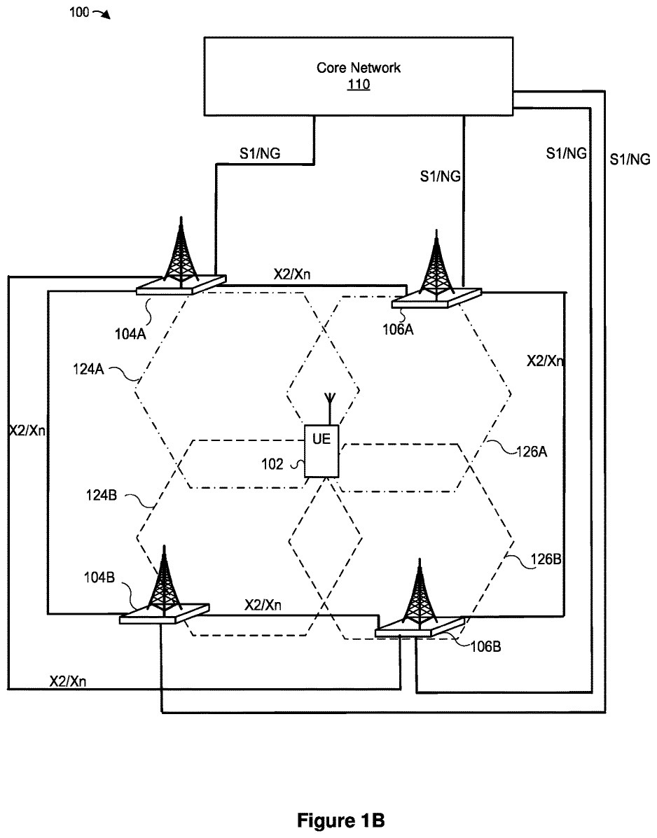

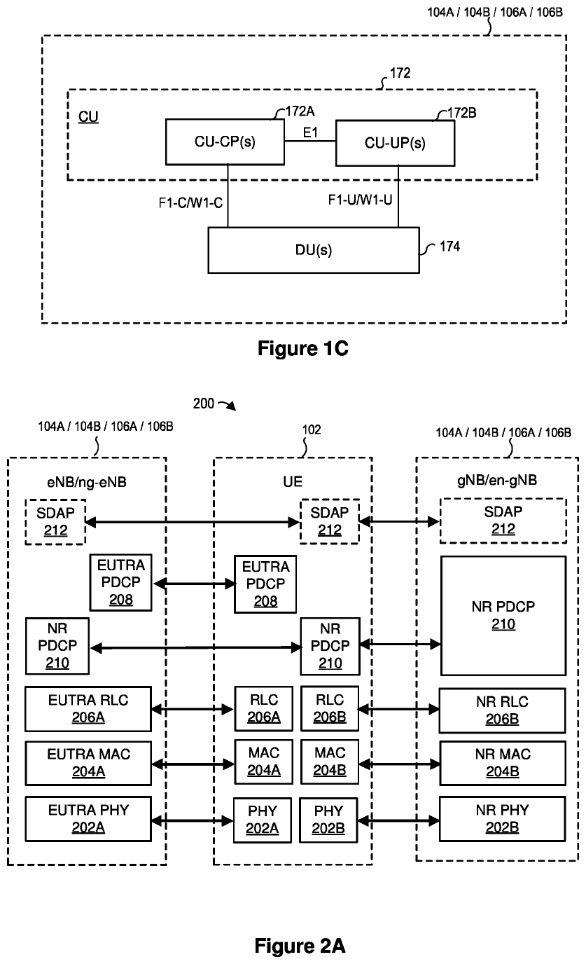

Referring first to FIG. 1A, an example wireless communication system 100 includes a UE 102, a base station (BS) 104A, a base station 106A, and a core network (CN) 110. The base stations 104A and 106A can operate in a RAN 105 connected to the same core network (CN) 110. The CN 110 can be implemented as an evolved packet core (EPC) 111 or a fifth generation (5G) core (5GC) 160, for example.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc.; the AMF 164 is configured to manage authentication, registration, paging, and other related functions; and the SMF 166 is configured to manage PDU sessions.

As illustrated in FIG. 1A, the base station 104A supports a cell 124A, and the base station 106A supports a cell 126A. Further, each of the base stations 104A, 106A may support more than one cell. The base station 106A, for example, may also support a cell 126C. The cells 124A and 126A can partially overlap, so that the UE 102 can communicate in DC with the base station 104A and the base station 106A operating as a master node (MN) and a secondary node (SN), respectively. To directly exchange messages during DC scenarios and other scenarios discussed below, the MN 104A and the SN 106A can support an X2 or Xn interface. In general, the CN 110 can connect to any suitable number of base stations supporting NR cells and/or EUTRA cells. An example configuration in which the EPC 110 is connected to additional base stations is discussed below with reference to FIG. 1B.

The base station 104A is equipped with processing hardware 130 that can include one or more general-purpose processors such as CPUs and non-transitory computer-readable memory storing machine-readable instructions executable on the one or more general-purpose processors, and/or special-purpose processing units. The processing hardware 130 in an example implementation includes a conditional configuration controller 132 configured to manage conditional configuration for one or more conditional procedures such as Conditional Handover (CHO), Conditional PSCell Addition or Change (CPAC), or Conditional SN Additional or Change (CSAC), when the base station 104A operates as an MN.

The base station 106A is equipped with processing hardware 140 that can also include one or more general-purpose processors such as CPUs and non-transitory computer-readable memory storing machine-readable instructions executable on the one or more general-purpose processors, and/or special-purpose processing units. The processing hardware 140 in an example implementation includes a conditional configuration controller 142 configured to manage conditional configurations for one or more conditional procedures such as CHO, CPAC, or CSAC, when the base station 106A operates as an SN.

Still referring to FIG. 1A, the UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes a UE conditional configuration controller 152 configured to manage conditional configuration for one or conditional procedures.

More particularly, the conditional configuration controllers 132, 142, and 152 can implement at least some of the techniques discussed with reference to the messaging and flow diagrams below. Although FIG. 1A illustrates the conditional configuration controllers 132 and 142 as separate components, in at least some of the scenarios the base stations 104A and 106A can have similar implementations and in different scenarios operate as MN or SN nodes. In these implementations, each of the base stations 104A and 106A can implement both the conditional configuration controller 132 and the conditional configuration controller 142 to support MN and SN functionality, respectively.

In operation, the UE 102 can use a radio bearer (e.g., a DRB or an SRB) that at different times terminates at the MN 104A or the SN 106A. The UE 102 can apply one or more security keys when communicating on the radio bearer, in the uplink (from the UE 102 to a BS) and/or downlink (from a base station to the UE 102) direction. The UE in some cases can use different RATs to communicate with the base stations 104A and 106A. Although the examples below may refer specifically to specific RAT types, 5G NR or EUTRA, in general the techniques of this disclosure also can apply to other suitable radio access and/or core network technologies.

FIG. 1B depicts additional base stations 104B and 106B, which may be included in the wireless communication system 100. The UE 102 initially connects to the base station 104A. The BSs 104B and 106B may have similar processing hardware as the base station 106A. The UE 102 initially connects to the base station 104A.

In some scenarios, the base station 104A can perform immediate SN addition to configure the UE 102 to operate in dual connectivity (DC) with the base station 104A (via a PCell) and the base station 106A (via a PSCell other than cell 126A). The base stations 104A and 106A operate as an MN and an SN for the UE 102, respectively. The UE 102 in some cases can operate using the MR-DC connectivity mode, e.g., communicate with the base station 104A using 5G NR and communicate with the base station 106A using EUTRA, or communicate with the base station 104A using EUTRA and communicate with the base station 106A using 5G NR. Multi-connectivity coordination can help the two base stations coordinate shared UE capabilities including operational frequencies (e.g., band combinations, frequency ranges), UE measurements and reporting (e.g., intra-frequency measurements, inter-frequency measurements, inter-RAT measurements, measurement gaps), reception timing (e.g., DRX configurations, offset timing), and uplink power control (e.g., power headroom, maximum transmit power).

At some point, the MN 104A can perform an immediate SN change to change the SN of the UE 102 from the base station 106A (source SN, or “S-SN”) to the base station 104B (target SN, or “T-SN”) while the UE 102 is communicating in DC with the MN 104A and the S-SN 106A. In another scenario, the SN 106A can perform an immediate PSCell change to change the PSCell of the UE 102 to the cell 126A. In one implementation, the SN 106A can transmit a configuration changing the PSCell to cell 126A to the UE 102 via a signaling radio bearer (SRB) (e.g., SRB3) for the immediate PSCell change. In another implementation, the SN 106A can transmit a configuration changing the PSCell to the cell 126A to the UE 102 via the MN 104A for the immediate PSCell change. The MN 104A may transmit the configuration immediately changing the PSCell to the cell 126A to the UE 102 via SRB1. Extending multi-connectivity coordination can help the newly-added base station coordinate shared UE capabilities.

In other scenarios, the base station 104A can perform a conditional SN Addition procedure to first configure the base station 106B as a C-SN for the UE 102, i.e., conditional SN addition or change (CSAC). At this time, the UE 102 can be in single connectivity (SC) with the base station 104A or in DC with the base station 104A and the base station 106A. If the UE 102 is in DC with the base station 104A and the base station 106A, the MN 104A may determine to perform the conditional SN Addition procedure in response to a request received from the base station 106A or in response to one or more measurement results received from the UE 102 (e.g., extracted from a UE measurement report) or obtained by the MN 104A from measurements on signals (e.g., sounding reference signal (SRS) or uplink demodulation reference signal (DMRS)) received from the UE 102. In contrast to the immediate SN Addition case discussed above, the UE 102 does not immediately attempt to connect to the C-SN 106B. In this scenario, the base station 104A again operates as an MN, but the base station 106B initially operates as a C-SN rather than an SN.

More particularly, when the UE 102 receives a configuration for the C-SN 106B, the UE 102 does not connect to the C-SN 106B until the UE 102 has determined that a certain condition is satisfied (the UE 102 in some cases can consider multiple conditions, but for convenience only the discussion below refers to a single condition). Before the condition is satisfied, multi-connectivity coordination is not necessary; however, it will be helpful as soon as a C-SN becomes connected. When the UE 102 determines that the condition has been satisfied, the UE 102 connects to the C-SN 106B, so that the C-SN 106B begins to operate as the SN 106B for the UE 102. Thus, while the base station 106B operates as a C-SN rather than an SN, the base station 106B is not yet connected to the UE 102, and accordingly is not yet servicing the UE 102. In some implementations, the UE 102 may disconnect from the SN 106A to connect to the C-SN 106B.

In yet other scenarios, the UE 102 is in DC with the MN 104A (via a PCell) and SN 106A (via a PSCell other than cell 126A and not shown in FIG. 1A). The SN 106A can perform conditional PSCell addition or change (CPAC) to configure a candidate PSCell (C-PSCell) 126A for the UE 102. If the UE 102 is configured with a signaling radio bearer (SRB) (e.g., SRB3) to exchange RRC messages with the SN 106A, the SN 106A may transmit a configuration for the C-PSCell 126A to the UE 102 via the SRB, e.g., in response to one or more measurement results, which may be received from the UE 102 via the SRB or via the MN 104A or may be obtained by the SN 106A from measurements on signals received from the UE 102. In case of via the MN 104A, the MN 104A receives the configuration for the C-PSCell 126A. In contrast to the immediate PSCell change case discussed above, the UE 102 does not immediately disconnect from the PSCell and attempt to connect to the C-PSCell 126A.

More particularly, when the UE 102 receives a configuration for the C-PSCell 126A, the UE 102 does not connect to the C-PSCell 126A until the UE 102 has determined that a certain condition is satisfied (the UE 102 in some cases can consider multiple conditions, but for convenience only the discussion below refers to a single condition). When the UE 102 determines that the condition has been satisfied, the UE 102 connects to the C-PSCell 126A, so that the C-PSCell 126A begins to operate as the PSCell 126A for the UE 102. Thus, while the cell 126A operates as a C-PSCell rather than a PSCell, the SN 106A may not yet connect to the UE 102 via the cell 126A. In some implementations, the UE 102 may disconnect from the PSCell to connect to the C-PSCell 126A.

In some scenarios, the condition associated with CSAC or CPAC can be signal strength/quality, which the UE 102 detects on the C-PSCell 126A of the SN 106A or on a C-PSCell 126B of C-SN 106B, exceeding a certain threshold or otherwise corresponding to an acceptable measurement. For example, when the one or more measurement results the UE 102 obtains on the C-PSCell 126A are above a threshold configured by the MN 104A or the SN 106A or above a pre-determined or pre-configured threshold, the UE 102 determines that the condition is satisfied. When the UE 102 determines that the signal strength/quality on the C-PSCell 126A of the SN 106A is sufficiently good (again, measured relative to one or more quantitative thresholds or other quantitative metrics), the UE 102 can perform a random access procedure on the C-PSCell 126A with the SN 106A to connect to the SN 106A. After the UE 102 successfully completes the random access procedure on the C-PSCell 126A, the C-PSCell 126A becomes a PSCell 126A for the UE 102. The SN 106A then can start communicating data (user-plane data or control-plane data) with the UE 102 through the PSCell 126A. In another example, when the one or more measurement results the UE 102 obtains on the C-PSCell 126B are above a threshold configured by the MN 104A or the C-SN 106B or above a pre-determined or pre-configured threshold, the UE 102 determines that the condition is satisfied. When the UE 102 determines that the signal strength/quality on the C-PSCell 126B of the C-SN 106B is sufficiently good (again, measured relative to one or more quantitative thresholds or other quantitative metrics), the UE 102 can perform a random access procedure on the C-PSCell 126B with the C-SN 106B to connect to the C-SN 106B. After the UE 102 successfully completes the random access procedure on the C-PSCell 126B, the C-PSCell 126B becomes a PSCell 126B for the UE 102 and the C-SN 106B becomes an SN 106B. The SN 106B then can start communicating data (user-plane data or control-plane data) with the UE 102 through the PSCell 126B.

In various configurations of the wireless communication system 100, the base station 104A can be implemented as a master eNB (MeNB) or a master gNB (MgNB), and the base station 106A or 106B can be implemented as a secondary gNB (SgNB) or a candidate SgNB (C-SgNB). The UE 102 can communicate with the base station 104A and the base station 106A or 106B (106A/B) via the same RAT such as EUTRA or NR, or different RATs. When the base station 104A is an MeNB and the base station 106A is an SgNB, the UE 102 can be in EUTRA-NR DC (EN-DC) with the MeNB and the SgNB. In this scenario, the MeNB 104A may or may not configure the base station 106B as a C-SgNB to the UE 102. In this scenario, the SgNB 106A may configure cell 126A as a C-PSCell to the UE 102. When the base station 104A is an MeNB and the base station 106A is a C-SgNB for the UE 102, the UE 102 can be in SC with the MeNB. In this scenario, the MeNB 104A may or may not configure the base station 106B as another C-SgNB to the UE 102.

In some cases, an MeNB, an SeNB or a C-SgNB is implemented as an ng-eNB rather than an eNB. When the base station 104A is a Master ng-eNB (Mng-eNB) and the base station 106A is a SgNB, the UE 102 can be in next generation (NG) EUTRA-NR DC (NGEN-DC) with the Mng-eNB and the SgNB. In this scenario, the MeNB 104A may or may not configure the base station 106B as a C-SgNB to the UE 102. In this scenario, the SgNB 106A may configure cell 126A as a C-PSCell to the UE 102. When the base station 104A is an Mng-NB and the base station 106A is a C-SgNB for the UE 102, the UE 102 can be in SC with the Mng-NB. In this scenario, the Mng-eNB 104A may or may not configure the base station 106B as another C-SgNB to the UE 102.

When the base station 104A is an MgNB and the base station 106A/B is an SgNB, the UE 102 may be in NR-NR DC (NR-DC) with the MgNB and the SgNB. In this scenario, the MeNB 104A may or may not configure the base station 106B as a C-SgNB to the UE 102. In this scenario, the SgNB 106A may configure cell 126A as a C-PSCell to the UE 102. When the base station 104A is an MgNB and the base station 106A is a C-SgNB for the UE 102, the UE 102 may be in SC with the MgNB. In this scenario, the MgNB 104A may or may not configure the base station 106B as another C-SgNB to the UE 102.

When the base station 104A is an MgNB and the base station 106A/B is a Secondary ng-eNB (Sng-eNB), the UE 102 may be in NR-EUTRA DC (NE-DC) with the MgNB and the Sng-eNB. In this scenario, the MgNB 104A may or may not configure the base station 106B as a C-Sng-eNB to the UE 102. In this scenario, the Sng-eNB 106A may configure cell 126A as a C-PSCell to the UE 102. When the base station 104A is an MgNB and the base station 106A is a candidate Sng-eNB (C-Sng-eNB) for the UE 102, the UE 102 may be in SC with the MgNB. In this scenario, the MgNB 104A may or may not configure the base station 106B as another C-Sng-eNB to the UE 102.

The base stations 104A, 106A, and 106B can connect to the same core network (CN) 110, which can be an evolved packet core (EPC) 111 or a fifth-generation core (5GC) 160. The base station 104A can be implemented as an eNB supporting an S1 interface for communicating with the EPC 111, an ng-eNB supporting an NG interface for communicating with the 5GC 160, or as a base station that supports the NR radio interface as well as an NG interface for communicating with the 5GC 160. The base station 106A can be implemented as an EN-DC gNB (en-gNB) with an S1 interface to the EPC 111, an en-gNB that does not connect to the EPC 111, a gNB that supports the NR radio interface as well as an NG interface to the 5GC 160, or a ng-eNB that supports an EUTRA radio interface as well as an NG interface to the 5GC 160. To directly exchange messages during the scenarios discussed below, the base stations 104A, 106A, and 106B can support an X2 or Xn interface.

As illustrated in FIG. 1B, the base station 104A supports a cell 124A, the base station 104B supports a cell 124B, the base station 106A supports a cell 126A, and the base station 106B supports a cell 126B. The cells 124A and 126A can partially overlap, as can the cells 124A and 124B, so that the UE 102 can communicate in DC with the base station 104A (operating as an MN) and the base station 106A (operating as an SN) and, upon completing an SN change, with the base station 104A (operating as MN) and the SN 104B. More particularly, when the UE 102 operates in DC with the base station 104A and the base station 106A, the base station 104A operates as an MeNB, an Mng-eNB, or an MgNB, and the base station 106A operates as an SgNB or an Sng-eNB. The cells 124A and 126B can partially overlap. When the UE 102 is in SC with the base station 104A, the base station 104A operates as an MeNB, an Mng-eNB or an MgNB, and the base station 106B operates as a C-SgNB or a C-Sng-eNB. When the UE 102 operates in DC with the base station 104A and the base station 106A, the base station 104A operates as an MeNB, an Mng-eNB or an MgNB, the base station 106A operates as an SgNB or an Sng-eNB, and the base station 106B operates as a C-SgNB or a C-Sng-eNB.

In general, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network or 5G NR-6G DC.

FIG. 1C depicts an example distributed implementation of a base station such as the base station 104A, 104B, 106A, or 106B. The base station in this implementation can include a central unit (CU) 172 and one or more distributed units (DUs) 174. The CU 172 is equipped with processing hardware that can include one or more general-purpose processors such as CPUs and non-transitory computer-readable memory storing machine-readable instructions executable on the one or more general-purpose processors, and/or special-purpose processing units. In one example, the CU 172 is equipped with the processing hardware 130. In another example, the CU 172 is equipped with the processing hardware 140. The processing hardware 140 in an example implementation includes an (C-)SN RRC controller configured to manage or control one or more RRC configurations and/or RRC procedures when the base station 106A operates as an SN or a candidate SN (C-SN). The base station 106B can have hardware same as or similar to the base station 106A. The DU 174 is also equipped with processing hardware that can include one or more general-purpose processors such as CPUs and non-transitory computer-readable memory storing machine-readable instructions executable on the one or more general-purpose processors, and/or special-purpose processing units. In some examples, the processing hardware in an example implementation includes a medium access control (MAC) controller configured to manage or control one or more MAC operations or procedures (e.g., a random access procedure) and a radio link control (RLC) controller configured to manage or control one or more RLC operations or procedures when the base station 106A operates as an MN, an SN or a candidate SN (C-SN). The processing hardware may include further a physical layer controller configured to manage or control one or more physical layer operations or procedures.

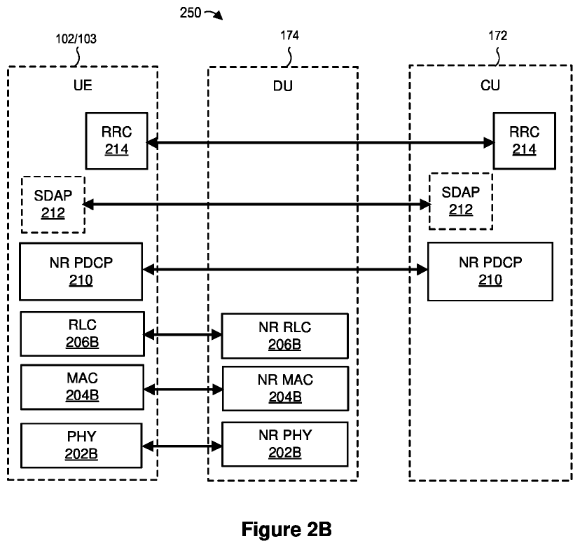

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to a EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2). The UE 102, in some implementations, supports both the EUTRA and the NR stack, as shown in FIG. 2, to support handover between EUTRA and NR base stations and/or to support DC over EUTRA and NR inteifaces. Further, as illustrated in FIG. 2, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or an RRC sublayer (not shown in FIG. 2) to exchange RRC messages or non-access-stratum (NAS) messages, for example. On a user plane, the EUTRA PDCP sublayer 208 and the NR PDCP sublayer 210 can provide data radio bearers (DRBs) to support data exchange. Data exchanged on the NR PDCP sublayer 210 can be SDAP PDUs, Internet Protocol (IP) packets, or Ethernet packets.

FIG. 2B illustrates, in a simplified manner, an example protocol stack 250 that the UE 102 can use to communicate with a DU (e.g., DU 174) and a CU (e.g., CU 172). The radio protocol stack 200 of FIG. 2A is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) can be delegated to the DU. To support connection to a 5GC, NR PDCP 210 provides SRBs to RRC 214, and NR PDCP 210 provides DRBs to SDAP 212 and SRBs to RRC 214.

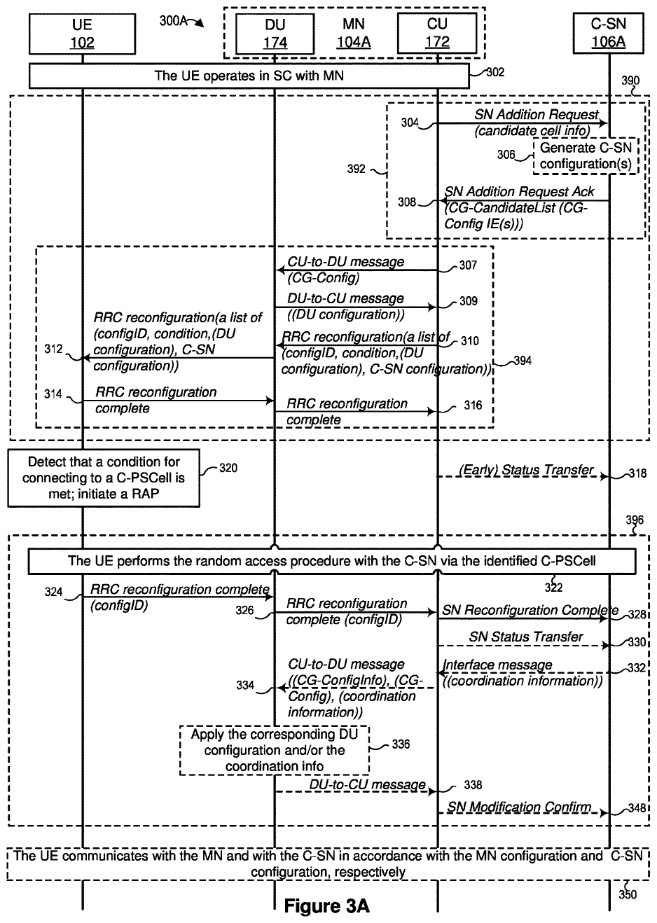

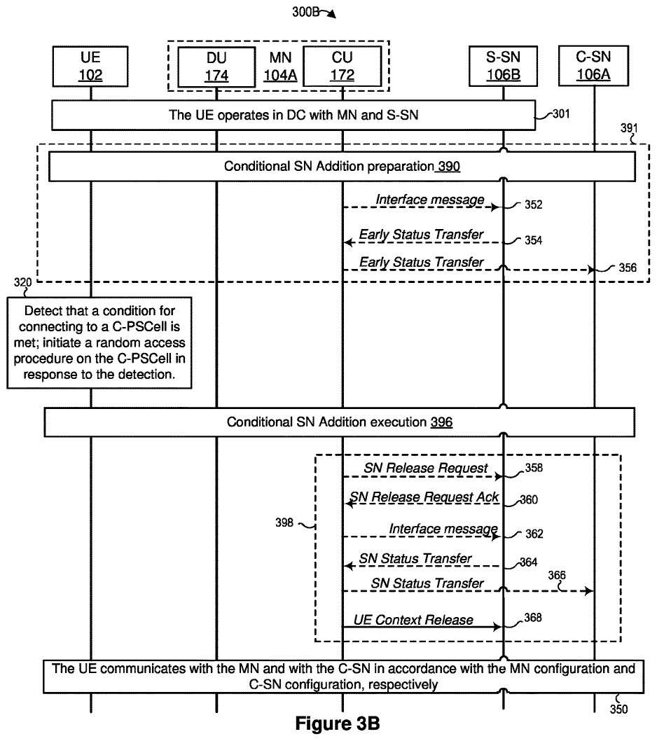

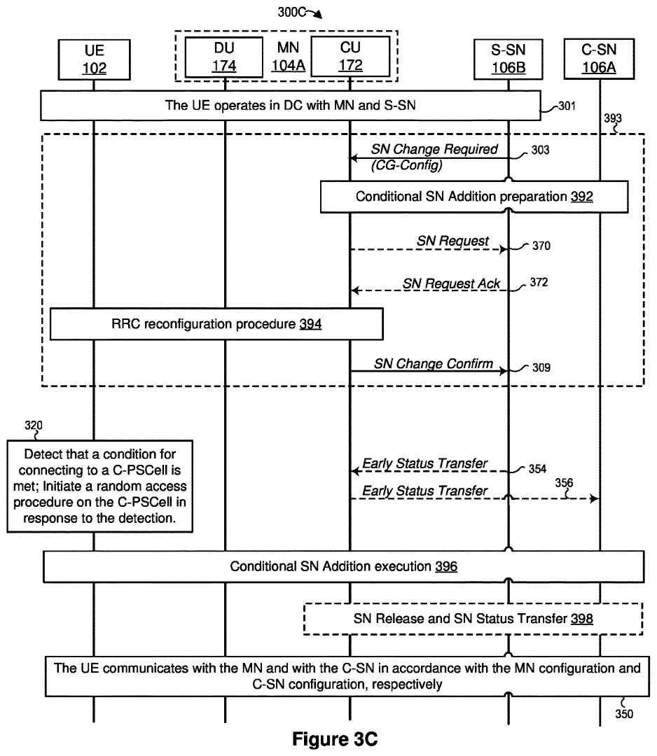

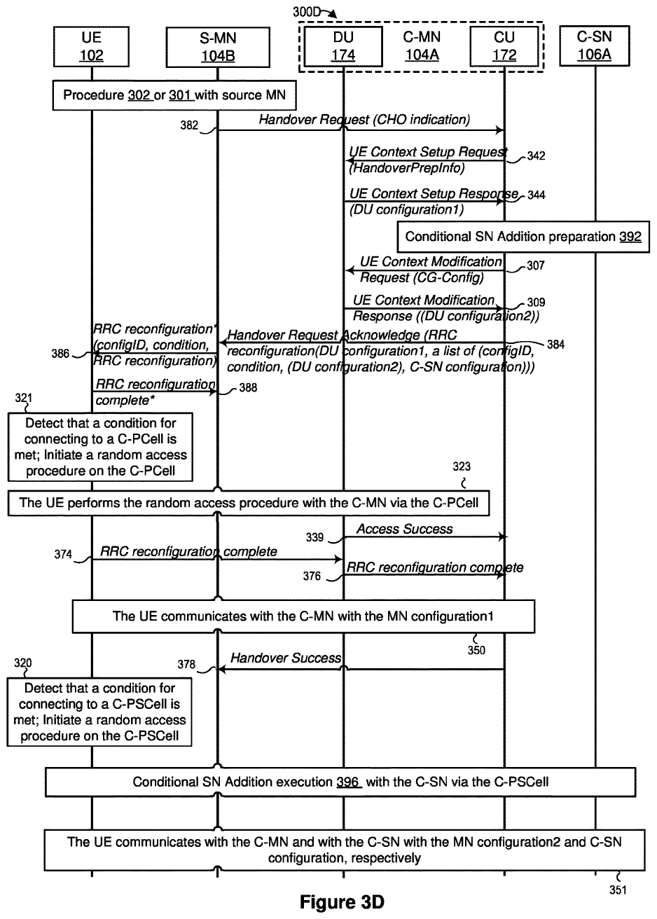

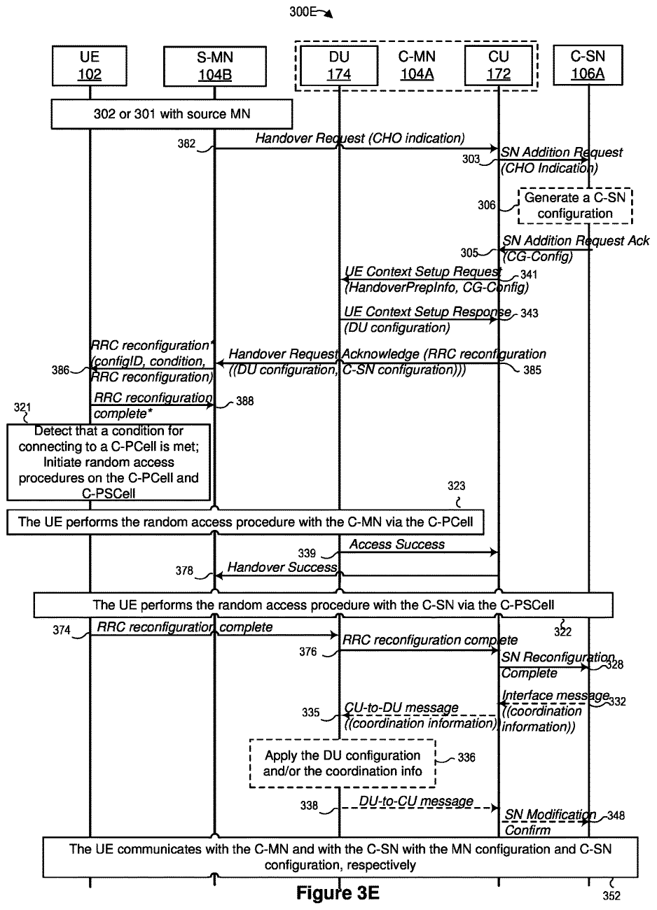

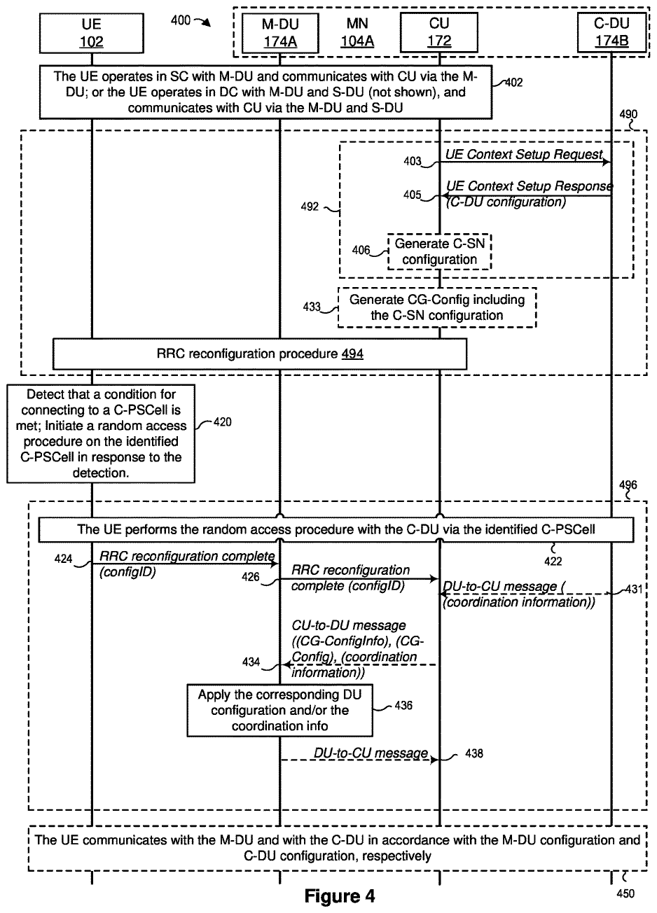

Next, several example scenarios in which a UE and/or a RAN perform the techniques of this disclosure for supporting conditional procedures are discussed with reference to FIGS. 3A-3E and 4. Generally speaking, similar events in FIGS. 3A-3E and 4 are labeled with the same reference numbers, with differences discussed below where appropriate.

Referring first to FIG. 3A, in a scenario 300A, an MN receives and processes one or more SN configurations from a C-SN during a conditional SN addition procedure. In the scenario 300A, the base station 104A operates as an MN, and the base station 106A operates as a C-SN. The MN 104A further includes a CU 172 and one or more DU(s) 174.

Initially, the UE 102 operates 302 in single connectivity (SC) with the MN 104A. While in SC, the UE 102 exchanges UL PDUs and/or DL PDUs with the MN 104A (e.g., via a PCell served by a DU 174) in accordance with an MN configuration. In some implementations, the MN configuration includes a first DU configuration the UE 102 previously received from the MN 104A. For example, the MN 104 can send the first DU configuration as a CellGroupConfig IE or includes configuration parameters in the CellGroupConfig IE, defined in 3GPP specification 38.331. In some implementations, the DU 174 generates the first DU configuration and transmits the first DU configuration to the CU 172, and the CU 172 transmits an RRC reconfiguration message including the first DU configuration via the DU 174 to the UE 102. The CU 172 receives an RRC reconfiguration complete message, in response to the RRC reconfiguration message, from the UE 102 via the DU 174 (e.g., similar to the events 310, 312, 314, 316 discussed in more detail below). After receiving the RRC reconfiguration complete message, the CU 172 sends to the DU 174 a CU-to-DU message (e.g., a UE Context Modification Request message) including an immediate indication (e.g., RRC Reconfiguration Complete Indicator IE) indicating that the UE 102 has received and/or applied the first DU configuration. For example, the CU 172 can set the RRC Reconfiguration Complete Indicator IE to a particular value (e.g., ‘true’) to indicate that UE 102 has received and/or applied the first DU configuration. In accordance with or in response to the immediate indication, the DU 174 applies the first DU configuration to communicate with the UE 102.

The MN 104A (in this scenario, the CU 172 of the MN 104A) later determines to configure the base station 106A as a C-SN for conditional PSCell addition (CPA). The MN 104A can make this determination based on measurement result(s) from the UE 102, for example. In some implementations, the MN 104A can detect or estimate that the UE 102 is moving toward coverage (i.e., one or more cells) of the base station 106A based on uplink signals received from the UE 102 or positioning measurement result(s) received from the UE 102. In response to the determination, the MN 104A (or the CU 172 of the MN 104A) sends 304 an SN Addition Request message including a Conditional PSCell Addition Information Request IE to the C-SN 106A. In some implementations, the Conditional PSCell Addition Information Request IE further includes a CPAC indicator to indicate CPAC-initiation and a Maximum Number of PSCells To Prepare IE/field. The MN 104A can generate candidate cell information including the measurement result(s) of the one or more cells and include the candidate cell information in the SN Addition Request message. Furthermore, the MN 104A (or the CU 172 of the MN 104A) can determine SN restriction information to restrict (values of) configuration parameters that the C-SN 106A can configure for the UE 102. The MN 104A can include the SN restriction information in the SN Addition Request message. The MN 104A (or the CU 172 of the MN 104A) may determine MN restriction information to restrict (values of) configuration parameters that the MN 104A can configure for the UE 102 when determining the SN restriction information. In some implementations, the MN restriction information and/or the SN restriction information include at least one of the fields shown in Table 1 below.

TABLE 1
Example fields in MN and/or SN restriction information

powerCoordination-FR1
Indicates the maximum power that the UE can use in FR1.
powerCoordination-FR2
Indicates the maximum power that the UE can use in frequency range 2 (FR2). This field is only used in NR-DC.
nrdc-PC-mode-FR1
Indicates the uplink power sharing mode that the UE uses in NR-DC FR1 (see TS 38.213 [13], clause 7.6).
nrdc-PC-mode-FR2
Indicates the uplink power sharing mode that the UE uses in NR-DC FR2 (see TS 38.213 [13], clause 7.6).
overheatingAssistanceSCG
Contains the UE's preference on reduced configuration for NR SCG to address overheating. This field is only used in
(NG)EN-DC.
p-maxEUTRA
Indicates the maximum total transmit power to be used by the UE in the E-UTRA cell group (see TS 36.104 [33]). This
field is used in (NG)EN-DC and NE-DC.
p-maxNR-FR1
Indicates the maximum total transmit power to be used by the UE in the NR cell group across all serving cells in frequency
range 1 (FR1) (see TS 38.104 [12]). The field is used in (NG)EN-DC and NE-DC.
p-maxUE-FR1
Indicates the maximum total transmit power to be used by the UE across all serving cells in frequency range 1 (FR1).
p-maxNR-FR1-MCG
Indicates the maximum total transmit power to be used by the UE in the NR cell group across all serving cells in frequency
range 1 (FR1) (see TS 38.104 [12]) the UE can use in NR MCG. This field is only used in NR-DC.
p-maxNR-FR2-SCG
Indicates the maximum total transmit power to be used by the UE in the NR cell group across all serving cells in frequency
range 2 (FR2) (see TS 38.104 [12]) the UE can use in NR SCG.
p-maxUE-FR2
Indicates the maximum total transmit power to be used by the UE across all serving cells in frequency range 2 (FR2).
p-maxNR-FR2-MCG
Indicates the maximum total transmit power to be used by the UE in the NR cell group across all serving cells in frequency
range 2 (FR2) (see TS 38.104 [12]) the UE can use in NR MCG.
pdcch-BlindDetectionSCG
Indicates the maximum value of the reference number of cells for PDCCH blind detection allowed to be configured for the
SCG.
configRestrictInfo
Includes fields for which SgNB is explicitly indicated to observe a configuration restriction.
drx-ConfigMCG
This field contains the complete DRX configuration of the MCG. This field is only used in NR-DC.
drx-InfoMCG
This field contains the DRX long and short cycle configuration of the MCG. This field is used in (NG)EN-DC and NE-DC.
drx-InfoMCG2
This field contains the drx-onDurationTimer configuration of the MCG. This field is only used in (NG)EN-DC.
fr-InfoListMCG
Contains information of FR information of serving cells that include PCell and SCell(s) configured in MCG.
maxToffset
Indicates the maximum Toffset value the SN is allowed to use for scheduling SCG transmissions (see TS 38.213 [13]). This
field is used in NR-DC only when the fields nrdc-PC-mode-FR1-r16 or nrdc-PC-mode-FR2-r16 are set to dynamic. Value
ms0dot5 corresponds to 0.5 ms, value ms0dot75 corresponds to 0.75 ms, value ms1 corresponds to 1 ms and so on.

In some implementations, the MN 104A (or the CU 172 of the MN 104A) can determine the MN restriction information and the SN restriction information in accordance with capabilities of the UE 102. More specifically, the MN 104A determines the MN restriction information and the SN restriction information such that when the UE 102 simultaneously communicates with the MN 104A and C-SN 106A, the communication with the MN 104A and C-SN 106A does not exceed a capability of the UE 102. For example, the MN 104A can determine a maximum uplink power, that MN 104A allows the UE 102 to transmit in communication with the MN 104A, in the MN restriction info, and the MN 104A can determine a maximum uplink power, that C-SN 106A allows the UE 102 to transmit in communication with the C-SN 106A, in the SN restriction information.

In response to receiving 304 the SN Addition Request message, the C-SN 106A determines 306 one or more C-PSCells (C-PSCell(s)) and generates one or more C-SN configurations (C-SN configuration(s)), each C-SN configuration associated with a particular C-PSCell of the C-PSCell(s), for the UE 102. For example, the C-PSCells may be the cell 126A and the cell 126C. In some implementations, the C-SN 106A determines the C-PSCell(s) and the C-SN configuration(s) based at least in part on the candidate cell information and the SN restriction information. The C-SN 106A generates an inter-node RRC message CG-CandidateList to include a list of CG-CandidateInfo element, such that each CG-CandidateInfo corresponds to a C-PSCell and includes C-PSCell information such as the C-PSCell ID (e.g., SSB frequency/ARFCN-ValueNR and the physical Cell ID) and a CG-Config (e.g., the inter-node RRC message CG-Config defined in 3GPP TS 38.331), to include the C-SN configuration and parameters for the MN 104A to prepare conditional configuration(s). In some implementations, each CG-CandidateInfo IE is included in a specific CG-CandidateToAddModList within the CG-CandidateList. The C-SN 106A transmits 308 an SN Addition Request Acknowledge message including the CG-CandidateList to the MN 104A (or the CU 172 of the MN 104A). In further implementations, the C-SN 106A can generate coordination information and include the coordination information in the SN Addition Request Acknowledge message. In some implementations, the coordination information includes one or more coordination parameters. In some implementations, the C-SN 106A can include the one or more coordination parameters in the respective CG-Config(s) in the CG-CandidateList and/or in the IEs other than the SN to MN Container (e.g., S-NG-RAN node to M-NG RAN node Container or SgNB to MeNB Container) in the SN Addition Request Acknowledge message. For example, the coordination information can include coordination parameters such as a Resource Coordination Information IE (e.g., SgNB Resource Coordination Information IE or MR-DC Resource Coordination Information IE) associated to a particular C-PSCell, one or more power coordination parameters (e.g., powerCoordination-FR1 and/or powerCoordination-FR2), or a discontinuous reception (DRX) configuration (e.g., DRX-Info or DRX-Info2). The coordination information can include coordination information for each of the C-PSCell(s). As another example, the coordination parameters can include one or more coordination parameters as shown in Table 2 below.

TABLE 2
Example Coordination Parameters

configRestrictModReq
Used by SN to request changes to SCG configuration restrictions previously set by MN to ensure UE capabilities are respected.
E.g. can be used to request configuring an NR band combination whose use MN has previously forbidden. SN only includes this
field in SN-initiated procedures.
drx-ConfigSCG
This field contains the complete DRX configuration of the SCG. This field is only used in NR-DC.
drx-InfoSCG
This field contains the DRX long and short cycle configuration of the SCG. This field is used in (NG)EN-DC and NE-DC.
drx-InfoSCG2
This field contains the drx-onDurationTimer configuration of the SCG. This field is only used in (NG)EN-DC.
fr-InfoListSCG
Contains information of FR information of serving cells that include PScell and SCells configured in SCG.
measuredFrequenciesSN
Used by SN to indicate a list of frequencies measured by the UE.
needForGaps
In NE-DC, indicates whether the SN requests gNB to configure measurements gaps.
ph-InfoSCG
Power headroom information in SCG that is needed in the reception of PHR MAC CE of MCG
ph-Supplementary Uplink
Power headroom information for supplementary uplink. In the case of (NG)EN-DC and NR-DC, this field is only present when
two UL carriers are configured for a serving cell and one UL carrier reports type1 PH while the other reports type 3 PH.
ph-Typelor3
Type of power headroom for a certain serving cell in SCG (PSCell and activated SCells). Value type1 refers to type 1 power
headroom, value type3 refers to type 3 power headroom. (See TS 38.321 [3]).
ph-Uplink
Power headroom information for uplink.
pSCellFrequency, pSCellFrequencyEUTRA
Indicates the frequency of PSCell in NR (i.e., pSCellFrequency) or E-UTRA (i.e., pSCellFrequencyEUTRA). In this version of the
specification, pSCellFrequency is not used in NE-DC whereas pSCellFrequencyEUTRA is only used in NE-DC. pSCellFrequency
indicates the absolute FrequencySSB.
reportCGI-RequestNR, reportCGI-RequestEUTRA
Used by SN to indicate to MN about configuring reportCGI procedure. The request may optionally contain information about the
cell for which SN intends to configure reportCGI procedure. In this version of the specification, the reportCGI-RequestNR is used
in (NG)EN-DC and NR-DC whereas reportCGI-RequestEUTRA is used only for NE-DC.
requestedBC-MRDC
Used to request configuring a band combination and corresponding feature sets which are forbidden to use by MN (i.e. outside of
the allowedBC-ListMRDC) to allow re-negotiation of the UE capabilities for SCG configuration.
requestedMaxInterFreqMeasIdSCG
Used to request the maximum number of allowed measurement identities to configure for inter-frequency measurement. This field
is only used in NR-DC.
requested MaxIntraFreqMeasIdSCG
Used to request the maximum number of allowed measurement identities to configure for intra-frequency measurement on each
serving frequency.
requestedPDCCH-BlindDetectionSCG
Requested value of the reference number of cells for PDCCH blind detection allowed to be configured for the SCG.
requestedP-MaxEUTRA
Requested value for the maximum power for the serving cells the UE can use in E-UTRA SCG. This field is only used in NE-DC.
requestedP-MaxFRI
Requested value for the maximum power for the serving cells on frequency range 1 (FR1) in this secondary cell group (see TS
38.104 [12]) the UE can use in NR SCG.
requestedP-MaxFR2
Requested value for the maximum power for the serving cells on frequency range 2 (FR2) in this secondary cell group the UE can
use in NR SCG. This field is only used in NR-DC.
selectedBandCombination
Indicates the band combination selected by SN in (NG)EN-DC, NE-DC, and NR-DC. The SN should inform the MN with this
field whenever the band combination and/or feature set it selected for the SCG changes (i.e. even if the new selection concerns a
band combination and/or feature set that is allowed by the allowedBC-ListMRDC)
selectedToffset
$Indicates the value used by the SN for scheduling SCG transmissions ( i . e . {T}_{proc , SCG}^{max} , see TS 38.213 [ 13 ] ) . This field is used in NR -$
DC only when the fields nrdc-PC-mode-FR1-r16 or nrdc-PC-mode-FR2-r16 are set to dynamic. The SN can only indicate a value
that is less than or equal to maxToffset received from MN. This field is used in NR-DC only when MN has included the field
maxToffset in CG-ConfigInfo. Value ms0dot5 corresponds to 0.5 ms, value ms0dot75 corresponds to 0.75 ms, value ms1
corresponds to 1 ms and so on.
servCellInfoListSCG-EUTRA
Indicates the carrier frequency and the transmission bandwidth of the serving cell(s) in the SCG in intra-band NE-DC. The field is
needed when MN and SN operate serving cells in the same band for either contiguous or non-contiguous intra-band band
combination or LTE NR inter-band band combinations where the frequency range of the E-UTRA band is a subset of the
frequency range of the NR band (as specified in Table 5.5B.4.1-1 of TS 38.101-3 [34]) in NE-DC.
servCellInfoListSCG-NR
Indicates the frequency band indicator, carrier center frequency, UE specific channel bandwidth and SCS of the serving cell(s) in
the SCG in intra-band (NG)EN-DC. The field is needed when MN and SN operate serving cells in the same band for either
contiguous or non-contiguous intra-band band combination or LTE NR inter-band band combinations where the frequency range
of the E-UTRA band is a subset of the frequency range of the NR band (as specified in Table 5.5B.4.1-1 of TS 38.101-3 [34]) in
(NG)EN-DC.
transmissionBandwidth-EUTRA
Indicates the transmission bandwidth on an E-UTRA carrier frequency as defined by the parameter Transmission Bandwidth
Configuration “NRB” TS 36.104 [33]. The values rb6, rb15, rb25, rb50, rb75, rb100 indicate 6, 15, 25, 50, 75 and 100 resource
blocks respectively.
ueAssistanceInformationSCG
Includes for each UE assistance feature associated with the SCG, the information last reported by the UE in the NR
UEAssistance Information message for the SCG, if any.

In some implementations, the C-SN 106A includes SN restriction information in the SN Addition Request Acknowledge message, which the MN 104A may use to determine the MN restriction information.

After receiving 308 the CG-CandidateList including the CG-Config IE(s), and before determining to which of the candidate cells the UE 102 has connected, the CU 172 transmits 307 a CU-to-DU message including the CG-CandidateList to the DU 174. In some implementations, in response to the CU-to-DU message including the CG-CandidateList IE and/or a conditional indication, the DU 174 can transmit 309 a single DU-to-CU message which may include a list of DU configuration(s) (e.g., a list of CellGroupConfig(s)) corresponding of each of the CG-Config 1E(s) in the CG-CandidateList IE. Alternatively, the CU 172 retrieves the CG-Config IE(s) from the CG-CandidateList, and for each of the CG-Config IE(s), the CU 172 transmits 307 a CU-to-DU message including the CG-Config IE to the DU 174. If the CU 172 received 308 restriction and/or coordination information, the CU 172 may include the restriction and/or coordination information in the CU-to-DU message that the CU 172 transmits 307. In some implementations, the CU-to-DU message is a UE Context Modification Request message. In response to (each of) the CU-to-DU message(s) of the event 307, the DU 174 can transmit 309 a DU-to-CU message to the CU 172. In some implementations, the DU-to-CU message is a UE Context Modification Response message.

In some implementations, for the (each) CG-Config IE(s), the DU 174 determines whether to prepare a DU configuration for the UE 102 based on the (each) CG-Config IE. For the (each) CG-Config IE(s), if the DU 174 determines that the CG-Config IE or the C-SN configuration in the CG-Config IE impacts the first DU configuration, the DU 174 can prepare a DU configuration (e.g., a CellGroupConfig) to update the first DU configuration. For example, the DU 174 determines that simultaneously applying the first DU configuration and the C-SN configuration exceed capabilities of the UE 102. In another example, the DU 174 determines that the first DU configuration has a conflict or is not compatible with the CG-Config IE or C-SN configuration. With these examples, the DU 174 determines that the CG-Config TE or C-SN configuration impacts the first DU configuration. Otherwise, if the DU 174 determines that the CG-Config IE or the C-SN configuration does not impact the first DU configuration, the DU 174 might not prepare a DU configuration to update the first DU configuration. In some implementations, the DU 174 generates the DU configuration(s) 1, . . . , N for CG-Config IE(s) 1, . . . , N of the CG-Config IE(s) to update the first DU configuration, respectively. Nis an integer and larger than zero. In some implementations, the DU 174 can store the CG-Config IE(s) and associate the DU configuration(s) to the CG-Config IE(s) 1, . . . , N. In other implementations, the DU 174 stores the C-SN configuration(s) 1, . . . , N in the CG-Config IE(s) 1, . . . , N, respectively and associates the DU configuration(s) 1, . . . , N to the C-SN configuration(s) 1, . . . , N, respectively. In yet other implementations, the DU 174 stores C-PSCell information 1, . . . , N in the CG-Config IE(s) 1, . . . , N, respectively and associates the DU configuration(s) 1, . . . , N to the C-PSCell information 1, . . . , N, respectively. In some implementations, for each of the CG-Config IE(s), the CU 172 might include a conditional indication in the respective CU-to-DU message of the event 307. The conditional indication indicates the corresponding CG-Config IE for CPA or CPC. Based on the conditional indication, the DU 174 might refrain from applying the DU configuration(s) 1, . . . , N. In some implementations, the conditional indication is a Conditional MCG Information IE with a CPAC Trigger field set to CPAC-initiation. In some implementations, the DU 174 generates the DU configurations(s) 1, . . . , N (e.g., a CellGroupConfig) without including a reconfigurationWithSync IE/field in each of the DU configuration. In some implementations, the DU 174 does not include the reconfigurationWithSync IE/field in the DU configuration(s) because of the specific conditional indication IE in the CU-to-DU message of the event 307. In other implementations, the DU does not include the reconfigurationWithSync IE/field in the DU configuration(s) because that the CU-to-DU message of the event 307 does not include a SpCell ID IE.

After receiving 308 the CG-Candidate List, for each entry in the CG-CandidateList, the CU 172 of the MN 104A retrieves and correlates the C-PSCell ID and the C-SN configuration and can use the C-PSCell ID and/or the C-SN ID (e.g., Global en-gNB ID, or Global NG-RAN Node ID) for differentiating and managing the C-SN configuration to prepare a conditional configuration. The CU 172 can assign a particular configuration ID (e.g., condReconfigId or CondReconfigurationId) to each of the C-SN configuration(s). The CU 172 can generate the trigger condition configurations (e.g., condExecutionCond or triggerCondition) for each of the C-SN configuration(s). Each of the trigger condition configurations can link to one or more measurement configurations that triggers the UE 102 to connect to the C-SN 106A via a particular C-PSCell configured in a particular C-SN configuration. In some implementations, the CU 172 can generate a conditional (re)configuration IE (e.g., ConditionalReconfiguration) to include a list of the C-SN configuration(s) with the corresponding configuration ID and trigger condition configuration(s). The CU 172 includes the conditional (re)configuration IE in an RRC reconfiguration message (e.g., RRCConnectionReconfiguration message or RRCReconfiguration message). In some implementations, if the CU 172 receives the DU configuration(s) 1, . . . , N from the DU 174 as described above, the CU 172 includes each of the DU configuration(s) 1, . . . , N with the respective C-SN configuration in the conditional (re)configuration IE. The CU 172 can transmit 310 the RRC reconfiguration message to the DU 174 in a CU-to-DU message (e.g., DL RRC Message Transfer or UE Context Modification Request message). The DU 174 transmits 312 the RRC reconfiguration message including the conditional (re)configuration fields/IEs to the UE 102. The UE 102 applies the RRC reconfiguration and replies 314 an RRC reconfiguration complete message (e.g., RRCConnectionReconfigurationComplete messages or RR CReconfigurationComplete message) to the DU 174. The DU 174 then transmits 316 the RRC reconfiguration complete message in a DU-to-CU message (e.g., UL RRC Message Transfer message or UE Context Modification Response message) to the CU 172. The events 304, 306, 307, 309, 308, 310, 312, 314, and 316 can be collectively referred as an MN-initiated Conditional SN Addition preparation 390. The events 304, 306, 308 can further be collectively referred as a Conditional SN Addition preparation 392, while the events 307, 309, 310, 312, 314, and 316 can be collectively referred as an RRC reconfiguration procedure 394. After receiving 316 the RRC reconfiguration complete message or an acknowledgement (e.g., RLC acknowledgement or hybrid automatic repeat request (HARQ) acknowledgement) for a PDU (e.g., RLC PDU or MAC PDU) including the RRC reconfiguration message, the CU 172 of the MN 104A can transmit 318 an Early Status Transfer message to the C-SN 106A to transfer a COUNT value of the first downlink SDU that the MN 104A forwards to the C-SN 106A or a COUNT value for discarding of already forwarded downlink SDUs for each of DRB(s) of the UE 102. The Early Status Transfer message may be an Early Sequence Number (SN) Status Transfer message, where “SN” in this context refers to sequence number rather than secondary node. The MN 104A can send 318 the Early Status Transfer message without receiving an interface message indicating the UE 102 connects to the C-SN 106A.

In some implementations, before the UE detects that a condition for connecting to a C-PSCell is met, the MN 104A might perform an MN-initiated SN modification procedure with the C-SN 106A and obtain a (updated) CG-Config IE or a (updated) CG-CandidateList IE in the SN Modification Request Acknowledge message from the C-SN 106A similar to event 392. In other implementations, before the UE detects that a condition for connecting to a C-PSCell is met, the C-SN 106A might perform an SN-initiated SN modification procedure with the MN 104A and provide a (updated) CG-Config IE or a (updated) CG-CandidateList IE in the SN Modification Required message to the MN 104A similar to event 392. The CU 172 might therefore perform another RRC reconfiguration procedure similar to event 394 with the DU 174 and UE 102 as described above to update the DU configuration and the UE configuration accordingly. In some implementations, the conditional indication in the event 307 for the updating RRC reconfiguration procedure(s) is a Conditional MCG Information IE with a CPAC Trigger field set to CPAC-initiation or CPAC-replace and the DU 174 replaces the existing prepared conditional configuration identified by the gNB-DU UE F1AP ID IE. In other implementations, the conditional indication in the event 307 for the updating RRC reconfiguration procedure(s) is a Conditional MCG Information IE with a CPAC Trigger set to CPAC-cancel and the DU 174 considers that the CU 172 is about to remove any reference to, and release any resources previously reserved for coordinating with the C-PSCells associated to the UE-associated signalling identified by the gNB-CU UE F1AP ID IE and the gNB-DU UE F1AP ID IE. If the Candidate Cells To Be Cancelled List IE is also included in the UE Context Modification Request message, the DU 174 shall consider that only the resources reserved for coordinating with the C-PSCells identified by the included Cell IDs (e.g., NR CGIs) are about to be released by the CU 172.

Later in time, if the UE 102 detects 320 that a condition for connecting to a C-PSCell is satisfied, the UE 102 connects to the C-PSCell. That is, the condition (or “triggering condition”) triggers the UE 102 to connect to the C-PSCell or to execute the C-SN configuration concerning the C-PSCell. In response to the detection, the UE 102 initiates a random access procedure on the C-PSCell. In response to the initiation, the UE 102 performs 322 the random access procedure with the C-SN 106A via the identified C-PSCell. In response to the detection or initiation 320, the UE 102 sends 324 an RRC reconfiguration complete message to the MN 104A via the DU 174. The DU 174 transmits 326 the RRC reconfiguration complete message in a DU-to-CU message (e.g., UL RRC Message Transfer message) to the CU 172. The UE 102 can transmit 324 the RRC reconfiguration complete message before, during or after the random access procedure.

In some implementations, the UE 102 may indicate, in the RRC reconfiguration complete message, that the UE 102 has executed one of the C-SN configuration(s) by including a configuration ID corresponding to the particular C-SN configuration. The CU 172 of the MN 104A can use the configuration ID to identify or determine the ID of the C-PSCell (e.g., the PCI and/or the CGI of the C-PSCell) and/or the C-SN if the MN 104A performs multiple CPA procedures with different C-SNs.

In response to or after receiving 326 the RRC reconfiguration complete message, the CU 172 of the MN 104A can transmit 328 an SN message to the C-SN 106A. In some implementations, the SN message can be an SgNB Reconfiguration Complete or S-Node Reconfiguration Complete message. In other implementations, the SN message can be an RRC Transfer message. In yet other implementations, the SN message can be a new interface message (e.g., XnAP or X2AP message) defined in 3GPP 38.423 or 36.423 release 17 or future specifications. In some implementations, the UE 102 can include an SN RRC message (e.g., RRCConnectionReconfigurationComplete or RRCReconfigurationComplete message) in the RRC reconfiguration complete message that the UE 102 transmits at event 324. In such cases, the MN 104A can include the SN RRC message in the SN message.

In some implementations, the random access procedure can be a four-step random access procedure or a two-step random access procedure. In other implementations, the random access procedure can be a contention-based random access procedure or a contention-free random access procedure. For example, the UE 102 may include an RRC reconfiguration complete message in a message 3 of the four-step random access procedure or in a message A of the two-step random access procedure.

After the C-SN 106A successfully completes the random access procedure with the UE 102, the C-SN 106A can send 332 an interface message (e.g., SN Modification Required message, an NG-RAN node Configuration Update message, a E-UTRA—NR Cell Resource Coordination Request message, or a success indication message), which may include the PSCell information of the PSCell (e.g., cell 126A), and/or the corresponding CG-Config IE for the executed C-SN configuration, and/or coordination information (e.g., SgNB Resource Coordination Information IE or MR-DC Resource Coordination Information IE) for Physical Resource Block (PRB) coordination to the CU 172 of the MN 104A. The PSCell information can include a cell global identity (CGI), a physical cell identity (PCI), and/or an absolute radio frequency channel number (ARFCN) identifying a DL carrier frequency of the PSCell 126A. In some implementations, the C-SN 106A can send 332 the interface message in response to or after receiving the SN message or performing 322 the random access procedure. In some implementations, the interface message further includes the SN restriction information. The MN 104A (the CU 172 and/or the DU 174) may use the SN restriction information to determine the MN restriction information.

In some implementations, in response to or after receiving 326 the RRC reconfigurations, the CU 172 of the MN 104A can also use the configuration ID to determine (e.g., identify or select) the CG-Config corresponding to the C-PSCell out of the CG-CandidateList received in event 308. In such case, the C-SN 106A might not include the CG-Config in the interface message at event 332 or the C-SN 106A might not transmit 332 the interface message (e.g., if the C-SN 106A previously transmitted the coordination information to the MN 104A at event 308).

The CU 172 of the MN 104A may, after or in response to the event 326 or event 332 (i.e., after identifying, either based on event 326 or event 332, the C-PSCell to which the UE has connected), transmit 334 a CU-to-DU message (e.g., UE Context Modification Request message), which may include a CG-ConfigInfo (e.g., the inter-node RRC message CG-ConfigInfo defined in 3GPP TS 38.331), and/or the CG-Config, and/or the C-PSCell ID corresponding to the C-PSCell to which the UE has connected, and/or the coordination information to the DU 174 of the MN 104A. The CU 172 can transmit the coordination information corresponding to the C-PSCell to which the UE has connected. In some implementations, the CG-ConfigInfo may include the MN restriction information. After receiving 334 the CU-to-DU message, the DU 174 of the MN 104A applies 336 the particular DU configuration and/or the coordination information. The DU 174 can then discard (i.e., release or stop applying) the CG-Config IE(s) and/or CG-ConfigInfo IE(s) and/or coordination information for the other candidate cells not connected to the UE 102.

In some implementations, the DU 174 can identify a particular DU configuration of the DU configuration(s), which corresponds to the CG-Config included in the CU-to-DU message of the event 334. The DU 174 can identify the particular DU configuration based on the association between the particular DU configuration and the CG-Config, C-SN configuration in the CG-Config, or C-PSCell information in the CG-Config. In some implementations, the CU 172 includes a conditional execution indication in the CU-to-DU message of the event 334. The conditional execution indication indicates that the C-SN configuration in the CG-Config is executed or applied by the UE 102. In response to the conditional execution indication, the DU 174 applies the identified DU configuration to communicate with the UE 102. In some implementations, the conditional execution indication is a Conditional MCG Information IE with a CPAC Trigger set to CPAC-execution. In other implementations, the CU 172 includes a RRC Reconfiguration Complete Indicator IE in the CU-to-DU message of the event 334. The RRC Reconfiguration Complete Indicator IE indicates that the C-SN configuration in the CG-Config is executed or applied by the UE 102. In response to the RRC Reconfiguration Complete Indicator IE, the DU 174 applies the identified DU configuration to communicate with the UE 102. In some implementations, the CU 172 can include both the RRC Reconfiguration Complete Indicator IE and the conditional execution indication in the CU-to-DU message of the event 334.

In some implementations, the DU 174 releases the rest of the DU configuration(s) 1, . . . , N in response to the CU-to-DU message of the event 334. In some implementations, the DU 174 releases the stored CG-Config IE(s), C-SN configuration(s) and/or the C-PSCell information in response to the CU-to-DU message of the event 334.

In some implementations, applying the MN restriction information and/or the coordination information means that, for example, the DU 174 configures an uplink power value within the maximum power allowable for the MCG (e.g., p-maxNR-FR1-MCG) considering also the requested maximum power of the SCG (e.g., requested-MaxFR1) and/or the UE capability (e.g., p-maxUE-FR1). As another example, the DU 174 may configure the PRBs for MCG not to overlap with the PRBs used or configured by the SCG (e.g., as indicated in the UL Coordination Information or DL Coordination Information field/IE). The DU 174 may transmit 338 a DU-to-CU message (e.g., UE Context Modification Response message) to the CU 172. In response to applying 336 the MN restriction information and/or the coordination information, if the MN restriction information and/or the coordination information had not been conditionally configured to the UE 102 in steps 310-312, the MN 104A may decide to transmit an RRC reconfiguration message including the configuration parameters to the UE 102. Therefore, the CU 172 transmits 340 the RRC reconfiguration message in a CU-to-DU message (e.g., DL RRC Message Transfer or UE Context Modification Request message) to the DU 174 and the DU 174 transmits 342 the RRC reconfiguration message to the UE 102. In some implementations, the configuration parameters 342 may reconfigure or release (values) of configuration parameters that the UE 102 uses to communicate with the MN 104A. In other implementations, the configuration parameters 342 may be new configuration parameters to configure the UE 102 to communicate with the MN 104A. In response to the RRC reconfiguration message 342, the UE 102 can send 344 an RRC reconfiguration complete message to the DU 174 and the DU 174 transmits 346 the RRC reconfiguration complete message to the CU 172 in a DU-to-CU message (e.g., UL RRC Message Transfer or UE Context Modification Request message). The CU 102 of the MN 104A may in response transmit 348 an SN Modification Confirm message (e.g., SgNB Modification Confirm or S-Node Modification Confirm message). The events 322, 324, 326, 328, 330, 332, 334, 336, 338, 340, 342, 344, 346, 348 can be collectively referred as a Conditional SN Addition execution procedure 396.

In response to or after receiving 326 the RRC reconfiguration complete message or 332 the interface message, the MN 104A can send 330 an SN Status Transfer message to transfer uplink PDCP SN and HFN receiver status and/or downlink PDCP SN and HFN transmitter status for each of DRB(s) of the UE 102. In contrast to event 318, the MN 104A sends 330 a (non-early) SN Status Transfer message.

After the UE 102 successfully completes 322 the random access procedure, the UE 102 communicates 350 with the MN and with the C-SN via the C-PSCell in accordance with the (updated) MN configuration and the C-SN configuration, respectively.

With continued reference to FIG. 3A, the C-SN configuration in some implementations can be a complete and self-contained configuration (i.e., a full configuration). The C-SN configuration may include a full configuration indication (an information element (IE) or a field) that identifies the C-SN configuration as a full configuration. The UE 102 in this case can use the C-SN configuration to communicate with the SN 106A without relying on an SN configuration. On the other hand, the C-SN configuration in other cases can include a “delta” configuration, or one or more configurations that augment a previously received SN configuration. In these cases, the UE 102 can use the delta C-SN configuration together with the SN configuration to communicate with the C-SN 106A.

The C-SN configuration can include multiple configuration parameters for the UE 102 to apply when communicating with the C-SN 106A via a C-PSCell. The multiple configuration parameters may configure the C-PSCell and zero, one, or more candidate secondary cells (C-SCells) of the C-SN 106A to the UE 102. The multiple configuration parameters may configure radio resources for the UE 102 to communicate with the C-SN 106A via the C-PSCell and zero, one, or more C-SCells of the C-SN 106A. The multiple configuration parameters may configure zero, one, or more radio bearers. The one or more radio bearers can include an SRB and/or one or more DRBs.

In some implementations, the C-SN configuration can include a group configuration (CellGroupConfig) IE that configures the C-PSCell and zero, one, or more C-SCells of the C-SN 106A. In one implementation, the C-SN configuration includes a radio bearer configuration. In another implementation, the C-SN configuration does not include a radio bearer configuration. For example, the radio bearer configuration can be a RadioBearerConfig IE, DRB-ToAddModList IE or SRB-ToAddModList IE, DRB-ToAddMod IE or SRB-ToAddMod IE. In various implementations, the C-SN configuration can be an RRCReconfiguration message, RRCReconfiguration-IEs, or the CellGroupConfig IE conforming to 3GPP TS 38.331. The full configuration indication may be a field or an IE conforming to 3GPP TS 38.331. In other implementations, the C-SN configuration can include an SCG-ConfigPartSCG-r12 IE that configures the C-PSCell and zero, one, or more C-SCells of the C-SN 106A. In some implementations, the C-SN configuration is an RR CConnectionReconfiguration message, RRCConnectionReconfiguration-IEs, or the ConfigPartSCG-r12 IE conforming to 3GPP TS 36.331. The full configuration indication may be a field or an IE conforming to 3GPP TS 36.331.

Still referring to FIG. 3A, the base station 106A (i.e., the C-SN) in some cases can also include the CU 172 and one or more DUs 174 as illustrated in FIG. 1C. For each of the C-SN configuration(s), the one or more DUs 174 can generate the C-SN configuration. Alternatively, for each of the C-SN configuration(s), the one or more DUs 174 can generate a portion of the C-SN configuration and the CU 172 may generate the remainder of the C-SN configuration. For example, the UE 102 performs 322 the random access procedure with the first DU 174A operating the (C-)PSCell and the first DU 174A may identify the UE 102 in the random access procedure. In this case, the UE 102 communicates 350 with the SN 106A via the first DU 174A.

The first DU 174A of the C-SN 106A operating the C-PSCell may generate the C-SN configuration configuring the C-PSCell or a portion of the C-SN configuration and send the C-SN configuration or the portion of the C-SN configuration to the CU 172. In cases involving generating a portion of the C-SN configuration, the CU 172 generates the remainder of the C-SN configuration. In some scenarios or implementations, the first DU 174A generates each of the other C-SN configuration(s). Alternatively, for each of the other C-SN configuration(s), the first DU 174A generates a portion of the C-SN configuration and the CU 172 generates the remainder of the C-SN configuration. In other scenarios or implementations, the first DU 174A generates at last one first C-SN configuration in the C-SN configuration(s). Alternatively, for each of the at least one first C-SN configuration, the first DU 174A generates a portion of the C-SN configuration and the CU 172 generates the remainder of the C-SN configuration. A second DU 174B of the C-SN 106A generates at least one second C-SN configuration in the C-SN configuration(s). Alternatively, for each of the at least one second C-SN configuration, the second DU 174B generates a portion of the C-SN configuration and the CU 172 generates the remainder of the C-SN configuration.

Referring next to FIG. 3B, a scenario 300B is similar to the scenario 300A. However, in the scenario 300B, the MN 104A initially operates in DC with a source SN (S-SN) 106B to connect to the UE 102 and later decides to perform a conditional SN change procedure. The interactions between MN 104A and C-SN 106A are similar to those described in FIG. 3A. The differences between FIGS. 3B and 3A are further described below.

The UE 102 is initially in dual connectivity 301 with the MN 104A and the S-SN 106B and communicates with the S-SN 106B via a PSCell in accordance with the S-SN configuration. Later in time, the MN 104A, C-SN 106A, and UE 102 performs the Conditional SN Addition preparation procedure 390. In cases where early data forwarding is needed, the MN 104A may transmit 352 an Interface message (e.g., Xn-U Address Indication or Data Address Indication message) to the S-SN 106B. The S-SN 106B then transmits 354 an Early Status Transfer message to the MN 104A and the MN 104A transmits 356 an Early Status Transfer message to the C-SN 106A. Events 390, 352, 354, and 356 can be collectively referred as an event 391 for MN-initiated Conditional SN Change preparation.

Similar to FIG. 3A, the UE 102 later detects 320 that a condition for connecting to the C-PSCell is met and performs a random access procedure on the C-PSCell in response to the detection with the C-SN 106A. The UE 102, MN 104A, and C-SN 106A performs the Conditional SN Addition execution 396. The MN 104A transmits 358 an SN Release Request message (e.g., SgNB Release Request or S-Node Release Request message) to the S-SN 106B. The S-SN 106B in response transmits 360 an SN Release Request Acknowledge message (e.g., SgNB Release Request Acknowledge or S-Node Release Request Acknowledge message). In cases where data forwarding is needed, the MN 104A may transmit 362 an Interface message (e.g., Xn-U Address Indication or Data Address Indication message) to the S-SN 106B to signal the forwarding address information for the user plane data. The S-SN 106B then may transmit 364 an SN Status Transfer message to the MN 104A and the MN 104A then may transmit 366 an SN Status Transfer message to the C-SN 106A. The MN 104A transmits 368 a UE Context Release message to the S-SN 106B. The events 358, 360, 362, 364, 366, and 368 can be collectively referred as an SN Release and SN Status Transfer procedure 398.

After the UE 102 successfully completes the 322 the random access procedure, the UE 102 communicates 350 with the MN and with the C-SN via the C-PSCell in accordance with the C-SN configuration.

Referring next to FIG. 3C, the scenario 300C depicts an SN-initiated conditional SN Change scenario where the MN 104A initially connects with an S-SN 106B and later is triggered by S-SN 106B to perform a conditional change procedure with the C-SN 106A. The interactions between MN 104A and C-SN 106A are similar to those described in FIG. 3A or 3B. The differences between FIG. 3C and FIGS. 3A and 3B are described below.

The S-SN 106B at some time point decides to initiate a conditional SN change procedure and transmits 303 an SN Change Required message (e.g., SgNB Change Required or S-Node Change Required message defined in the 3GPP TS 36.423 and 38.423, respectively) including a candidate/target SN ID (e.g., Global en-gNB ID, or Global NG-RAN Node ID, which, for example, refers to the C-SN 106A), and the CG-Config, which further includes the proposed candidate cell information (e.g., physical cell ID and/or related cell measurement results) and the trigger condition(s) (e.g., condExecutionCond-SCG IE, which may include measurement ID(s) referring to a configured S-SN measurement) for the corresponding candidate cell(s) to the MN 104A. The MN 104A and the C-SN 106A perform the Conditional SN Addition preparation procedure 392 with the proposed candidate cell information from the S-SN 106B. The MN 104A may transmit 370 an SN Request message (e.g., SgNB Modification Request or S-Node Modification Request message) to provide the candidate PSCell(s) accepted by the C-SN 106A to the S-SN 106B. The S-SN 106B in response may transmit 372 an SN Request Acknowledge message (e.g., SgNB Modification Request Acknowledge or S-Node Modification Request Acknowledge message) to provide the updated measurement configuration and/or trigger condition(s). The MN 104A performs 394 an RRC reconfiguration procedure with the UE 102. The MN 104A transmits 309 an SN Change Confirm message (e.g., SgNB Change Confirm or S-Node Change Confirm message) to the S-SN 106B. The events 303, 392, 370, 372, 394, and 309 can be collectively referred as the SN-initiated Conditional SN Change preparation procedure 393.

If the UE 102 later detects 320 that a condition for connecting to a C-PSCell is met, similarly the UE 102 performs the random access procedure with the C-SN 106A via the C-PSCell, the Conditional SN Addition Execution procedure 396, and the SN Release and SN Status Transfer procedure 398. However, different from the scenario 300B, the MN 104A might not transmit 344 the SN Release Request message and the S-SN 106B might therefore not transmit 346 the SN Release Request Acknowledge message.

Referring next to FIG. 3D, the scenario 300D depicts a conditional handover with conditional SN Addition or Change scenario where the S-MN 104B initially connects with UE 102 and later initiates a CHO to the C-MN 104A which further perform a CPA procedure with the C-SN 106A. The interactions between C-MN 104A and C-SN 106A are similar to those described in FIGS. 3A-3C. The differences between FIG. 3D and FIGS. 3A-3C are described below.

Initially, the UE 102 operates 302 in single connectivity (SC) with the S-MN 104B or in dual connectivity 301 with the S-MN 104B and the S-SN 106B (not shown in the figure) and communicates with the S-SN 106B via a PSCell in accordance with the S-SN configuration. Later in time, the S-MN 104B decides to perform a conditional handover procedure for the UE 102 and transmits 382 a Handover Request message including a target Cell ID, a CHO indication (e.g., a Conditional Handover Information Request IE including a CHO trigger IE indicating “CHO-initiation”), a HandoverPreparationInformation IE, and/or measurement results from the UE 102 to the C-MN 104A. The measurement results may include some candidate cell information for the C-MN 104A to consider whether to trigger an SN addition procedure. In some implementations, the C-MN 104A may consider whether to trigger an SN addition procedure based on other parameters such as Expected UE Moving Trajectory, UE identity, UE mobility history or even blindly if there is no measurement results received. The CU 172 of the C-MN 104A decides to perform a CHO with CPAC procedure to prepare multiple C-PSCells along with the conditional handover. The CU 172 transmits 342 a UE Context Setup Request message to the DU 174 and includes a conditional indication (e.g., a Conditional Inter-DU Mobility Information indicating CHO-initiation) and the HandoverPreparationInformation IE. The DU 174 in response transmits 344 a UE Context Setup Response message including a first DU configuration to the CU 172. In some implementations, the DU 174 takes the received HandoverPreparationInformation IE into account and generates a CellGroupConfig IE to include the first DU configuration. In some implementations, the first DU configuration also includes a reconfigurationWithSync IE/field. The CU 172 performs 392 the Conditional SN Addition preparation procedure with the C-SN 106A, obtains a CG-CandidateList IE from the SN Addition Request Acknowledge message, and transmits 307 one or more UE Context Modification Request message(s) each including a CG-Config IE retrieved from the CG-CandidateList to the DU 174 as described in FIG. 3A. The CU 172 receives the UE Context Modification Response message from the DU 174 in response to the UE Context Modification Request message. In some implementations, the UE Context Modification Request message might include a second DU configuration which can update the first DU configuration when the dual connectivity takes effect. The CU 172 then generates a RRC reconfiguration message which includes the first DU configuration and one or more conditional (re)configuration IE(s) (e.g., CondReconfigurationToAddMod IEs or CondReconfigToAddMod IEs) including the one or more C-SN configuration(s) and/or the corresponding second DU configuration(s) as described in FIG. 3A. The CU 172 transmits 384 a Handover Request Acknowledge message to the S-MN 104B including the RRC reconfiguration message. The S-MN 104B generates an RRC reconfiguration* message including one or more conditional (re)configuration IE(s) (e.g., CondReconfigurationToAddMod IEs or CondReconfigToAddMod IEs) including the one or more RRC reconfiguration message(s) and transmits 386 the RRC reconfiguration* message to the UE 102. The UE 102 in response transmits 388 an RRC reconfiguration complete* message to the S-MN 104B.

The UE 102 later in time detects 321 that a condition for connecting to a C-PCell for conditional handover is met and initiates a random access procedure on the C-PCell. The UE performs 323 the random access procedure with the C-MN 104A via the C-PCell in the DU 174. The UE 102 also transmits 374 an RRC reconfiguration complete message to the DU 174 and the DU 174 forwards 376 the RRC reconfiguration complete message to the CU 172 in a DU-to-CU message (e.g., UL RRC Message Transfer message). The DU 174 also transmits 339 an Access Success message to the CU 172 after the random access procedure. The UE 102 communicates 350 with the C-MN 104A with the MN configuration which includes the first DU configuration. The CU 172 transmits 378 a Handover Success message to the S-MN 104B. The CU 172 might transmit a UE Context Release message to the S-MN 104B.

The UE 102 later in time detects 320 that a condition for connecting to a C-PSCell is met and initiates a random access procedure on the C-PSCell. The UE 102, DU 174, CU 172 and C-SN 106A perform 396 a Conditional SN Addition execution procedure via the C-PSCell similar to FIG. 3A. The UE 102 communicates with the C-MN 104A and with the C-SN 106A with the MN configuration and the C-SN configuration, respectively. The MN configuration may include the second DU configuration if the second DU configuration is provided to the CU 172 in event 309.

Referring next to FIG. 3E, the scenario 300E depicts a conditional handover with SCG configuration scenario where the S-MN 104B initially connects with UE 102 and later initiates a CHO with C-MN 104A which further perform a CPA procedure with the C-SN 106A. The interactions between C-MN 104A and C-SN 106A are similar to those described in FIGS. 3A-3D. The differences between FIG. 3E and FIGS. 3A-3D are described below.

After receiving 382 the Handover Request message, different from scenario 300D, the CU 172 decides to perform a CHO with SCG configuration procedure to prepare only one C-PSCell along with the conditional handover. The CU 172 transmits 303 a SN Addition Request message to the C-SN 106A including a CHO indication (e.g., CHO Information SN Addition IE) so that the C-SN 106A generates 306 a single C-SN configuration. The C-SN 106A transmits 305 a SN Addition Request Acknowledge message to the CU 172 including a CG-Config IE including the single C-SN configuration. The CU 172 transmits 341 a UE Context Setup Request message to the DU 174 including a conditional indication, the HandoverPreparationInformation IE, and the CG-Config IE. In some implementations, the conditional indication is a Conditional Inter-DU Mobility Information IE indicating CHO-initiation and/or a Conditional MCG Information IE indicating CPAC-initiation. The DU 174 in response transmits 343 a UE Context Setup Response message including a (first) DU configuration to the CU 172. In some implementations, the DU 174 takes the received HandoverPreparationInformation IE and the CG-Config IE into account and generates a CellGroupConfig IE to include the (first) DU configuration. In some implementations, the (first) DU configuration also includes a reconfigurationWithSync IE/field. The CU 172 then generates a RRC reconfiguration message which includes the (first) DU configuration and the C-SN configuration retrieved from the CG-Config IE. The CU 172 transmits 385 a Handover Request Acknowledge message to the S-MN 104B including the RRC reconfiguration message. The S-MN 104B generates an RRC reconfiguration* message including one or more conditional (re)configuration IE(s) (e.g., CondReconfigurationToAddMod IEs or CondReconfigToAddMod IEs) including the one or more RRC reconfiguration message(s) and transmits 386 the RRC reconfiguration* message to the UE 102. The UE 102 in response transmits 388 an RRC reconfiguration complete* message to the S-MN 104B.

The UE 102 later in time detects 321 that a condition for connecting to a C-PCell for conditional handover is met and initiates not only a random access procedures on the C-PCell and but also on the C-PSCell additionally compared to the scenario 300D. The UE performs 323 the random access procedure with the C-MN 104A via the C-PCell in the DU 174. The DU 174 also transmits 339 an Access Success message to the CU 172 after the random access procedure. The CU 172 transmits 378 a Handover Success message to the S-MN 104B. The CU 172 might transmit a UE Context Release message to the S-MN 104B. The UE performs 322 also the random access procedure with the C-SN 106A via the C-PSCell. The UE 102 transmits 374 an RRC reconfiguration complete message to the DU 174 and the DU 174 forwards 376 the RRC reconfiguration complete message to the CU 172 in a DU-to-CU message (e.g., UL RRC Message Transfer message). The CU 172 subsequently transmits 328 an SN Reconfiguration Complete message to the C-SN 106A. The C-SN 106A may transmit 332 an interface message (e.g., SN Modification Required message) to the CU 172 including a coordination information (e.g., MR-DC Resource Coordination Information IE). After or in response to 374 the RRC reconfiguration complete message, the CU 172 may transmit 335 a CU-to-DU message (e.g., UE Context Modification Request message) to the DU 174 which may include an RRC Reconfiguration Complete Indicator to indicate that the UE 102 has successfully applied the (first) DU configuration and/or the coordination information (e.g., Resource Coordination Transfer Container IE) if received from the C-SN 106A. In some implementations, the CU-to-DU message in event 335 does not include a CG-Config IE as there was only one C-SN configuration prepared. In some implementations, the CU-to-DU message in event 335 and the UE Context Setup Request message in event 341 contain the same gNB-CU UE F1AP ID and/or gNB-DU UE F1AP ID so that the DU 174 can identify the UE 102 and the corresponding (first) DU configuration. The DU 174 applies 336 the (first) DU configuration and/or the coordination information if received. The DU 174 transmits 338 a DU-to-CU message (e.g., UE Context Modification Response message) to the CU 172. The CU 172 may transmit 348 a SN Modification Confirm message in response to the interface message at event 332. The UE 102 communicates with the C-MN 104A and with the C-SN 106A with the MN configuration and C-SN configuration, respectively. The MN configuration including the (first) DU configuration and the (first) DU configuration already accommodates the MR-DC resource coordination.

Next, FIG. 4 illustrates a scenario 400 where the UE 102 is connected to a single base station (e.g., the MN 104A) and the base station later acts both as an MN and as an SN and configures both the MCG and SCG. The scenario 400 is similar to scenarios 300A-300C and the same actions and events are labeled with the same numbers. The differences between FIG. 4 and FIGS. 3A-3C are further described below.

The UE 102 initially operates 402 in SC with an M-DU 174A and communicates with the CU 172 via the M-DU 174A or operates 402 in DC with the M-DU 174A and an S-DU (for example, DU 174C, not shown in this figure) and communicates with the CU 172 via the M-DU 174A and the S-DU.

The CU 172 later transmits 403 one or more UE Context Setup Request message(s) including a conditional indication to the C-DU 174B. In response, the C-DU 174B transmits 405 one or more UE Context Setup Response message(s) including a C-DU configuration and/or a corresponding coordination information to the CU 172. The CU 172 may generate 406 a C-SN configuration based on the C-DU configuration. The CU 172 may generate 433 a CG-Config IE including the C-SN configuration and/or other coordination parameters. The CU 172 may also generate a CG-ConfigInfo IE including the MN restriction information. The CU 172, M-DU 174A, and UE 102 perform 494 an RRC reconfiguration procedure analogous to procedure 394. Events 403, 405, and 406 can be collectively referred as an event 492. Events 492 and 494 further can be collectively referred as a procedure 490 for Conditional SN Addition preparation in a single base station.

The UE 102 may later detect 420 that a condition for connecting to a C-PSCell is met and initiate a random access procedure on the identified C-PSCell in response to the detection. In response to the initiation, the UE 102 performs 422 the random access procedure with the C-DU 174B via the identified C-PSCell. In response to the detection or initiation 420, the UE 102 sends 424 an RRC reconfiguration complete message including the configuration ID corresponding to the C-PSCell to the CU 172 via the M-DU 174A. The M-DU 174A transmits 426 the RRC reconfiguration complete message in a DU-to-CU message (e.g., UL RRC Message Transfer message) to the CU 172. The UE 102 can transmit 424 the RRC reconfiguration complete message before, during or after the random access procedure. The C-DU 174B may transmit 431 a DU-to-CU message (e.g., Access Success, or UE Context Modification Required message) including a PSCell information (e.g., CGI) and/or the C-DU configuration and/or the corresponding coordination information. The CU 172 may transmit 434 a CU-to-DU message (e.g., UE Context Modification Request message), which may include a CG-ConfigInfo, and/or a CG-Config, and/or the C-PSCell ID corresponding to the C-PSCell to which the UE has connected, and/or the coordination information to the M-DU 174A, similar to the event 334. The M-DU 174A applies 436 the particular DU configuration (i.e., the (updated) M-DU configuration) and/or the coordination information, similar to the event 336. The M-DU 174A may transmit 438 a DU-to-CU message (e.g., UE Context Modification Response message) to the CU 172. The events 422, 424, 426, 431, 434, 436, 438 can be collectively referred as a Conditional SN Addition execution procedure in a single base station 496. The UE communicates 450 with the M-DU 174A and with the C-DU 174B in accordance with the M-DU configuration and the C-SN configuration, respectively.

In some implementations, if the above events concern a (MN- or SN-initiated) SN Change, the CU 172 may transmit a UE Context Release Command message to the S-DU after the successful execution of the C-SN configuration.

In some implementations, the CU 172 and a single DU 174 serve both the MCG and SCG in different cells. In such case, the events 403 and 405 can be a UE Context Modification Request and a UE Context Modification Response message, respectively, between the CU 172 and the M-DU 174A, for example. Similarly, the events 431 and 434 may also take place between the M-DU 174A and the CU 172, for example.

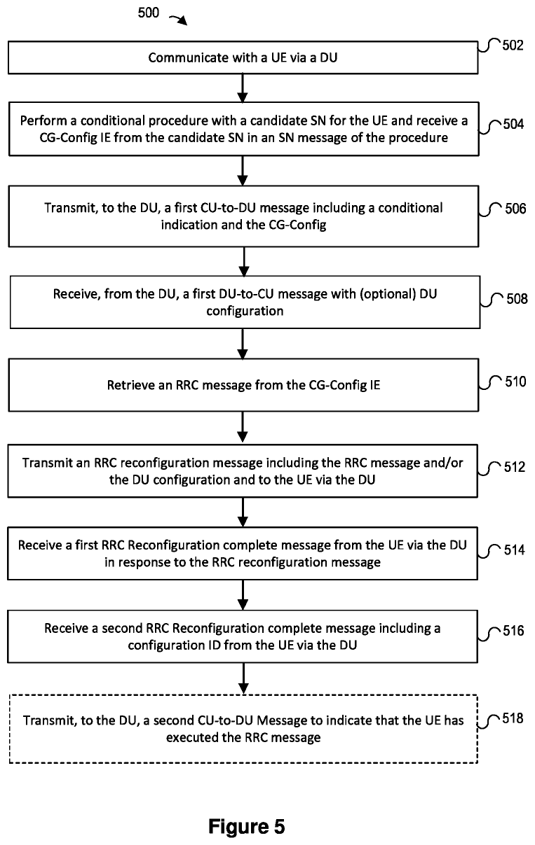

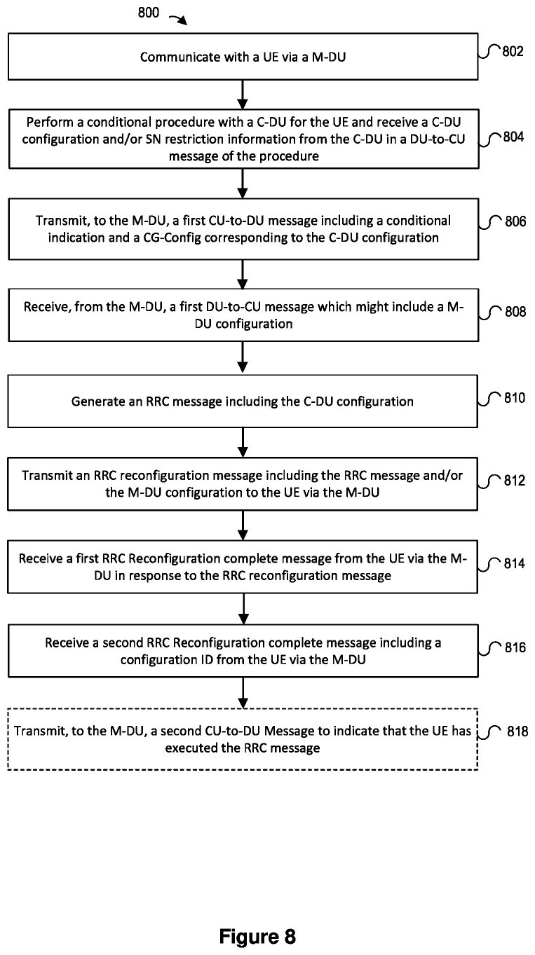

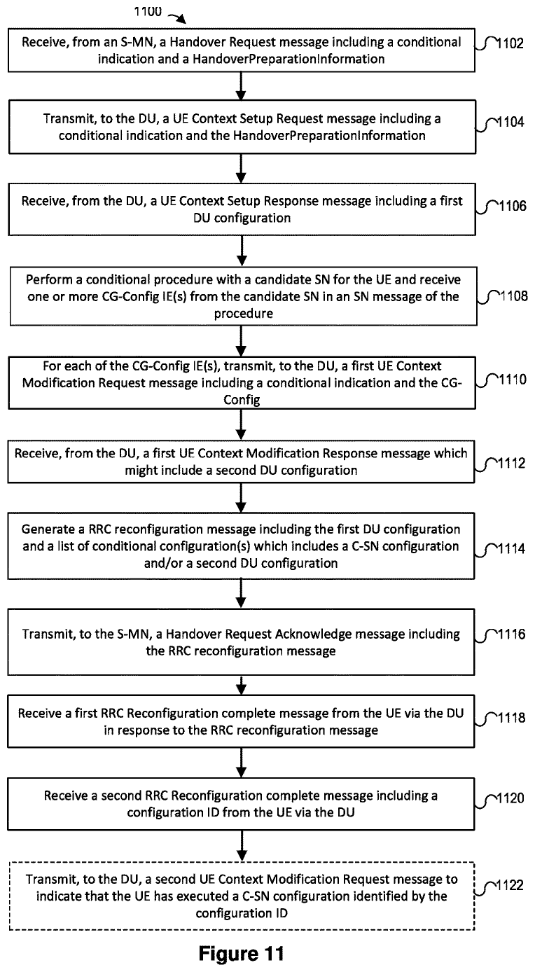

FIGS. 5-13 are flow diagrams depicting example methods that a base station CU (e.g., the CU 172 of the base station 104A) can implement to support conditional procedures in accordance with the techniques of this disclosure. As indicated at various points throughout this disclosure, the example methods depicted in FIGS. 5-13 may be implemented during the scenarios 300A-300E and 400 described above. In particular, FIGS. 5-7 illustrate conditional procedures that may be performed by two base stations (i.e., inter-base station conditional procedures, such as in scenarios 300A-300C), and FIGS. 8-10 illustrate similar conditional procedures that may be performed by a single base station (i.e., intra-base station conditional procedures, such as in scenario 400). FIGS. 11-13 illustrate conditional procedures concerning conditional handover that may be performed by three or four base stations (i.e., inter-base station conditional procedures, such as in scenarios 300D-300E).

Referring to FIG. 5, a method 500 where an MN-CU (e.g., the CU 172 of the MN 104A), performs a conditional SN procedure with a candidate SN (e.g., the C-SN 106A) for a UE (e.g., the UE 102) is described.

During the method 500, the CU at block 502 communicates with a UE via a DU. The CU at block 504 performs a conditional procedure (e.g., CPA or CPC) with a candidate SN for the UE and receive a CG-Config IE from the candidate SN in an SN message of the procedure (e.g., event 308). At block 506, the CU transmits, to the DU, a first CU-to-DU message including a conditional indication and the CG-Config IE (e.g., event 307). In some implementations, the first CU-to-DU message includes also the CG-ConfigInfo IE. In some implementations, the conditional indication is a Conditional MCG Information IE indicating CPAC-initiation. The CU at block 508 receives, from the DU, a first DU-to-CU message in response to the first CU-to-DU message (e.g., event 309). In some implementations, the DU-to-CU message might include a DU configuration (i.e., an MCG configuration). The CU at block 510 retrieves an RRC message (i.e., SN RRC message) from the CG-Config IE. In some implementations, the RRC message is or includes a C-SN configuration described above. At block 512, the CU transmits an RRC reconfiguration message including the RRC message and/or the DU configuration, if received, to the UE via the DU (e.g., events 310 and 312). In some implementations, if the CU receives the DU configuration, the CU includes the DU configuration and the SN RRC message in a conditional (re)configuration IE in the RRC reconfiguration message of block 512. In some implementations, the CU can generate an MN RRC message including the DU configuration and the SN RRC message and include the MN RRC message in the conditional (re)configuration IE. The CU at block 514 receives a first RRC Reconfiguration complete message from the UE via the DU in response to the RRC reconfiguration message (e.g., events 314 and 316). The CU at block 516 receives a second RRC Reconfiguration complete message including a configuration ID from the UE via the DU (e.g., events 324 and 326). At block 518 the CU might transmit, to the DU, a second CU-to-DU Message to indicate that the UE has executed the RRC message (e.g., event 334). In some implementations, the second CU-to-DU message includes the CG-Config and/or C-PSCell ID corresponding to the C-PSCell to which the UE has connected. In some implementations, the second CU-to-DU message includes a conditional execution indication. In other implementations, the second CU-to-DU message includes a RRC Reconfiguration Complete Indicator IE. In some implementations, the second CU-to-DU message includes both the RRC Reconfiguration Complete Indicator IE and the conditional execution indication.

In some implementations, the CU can transmit to the DU the second CU-to-DU message to indicate to the DU that the UE has executed the SN RRC message, after or in response to receiving the second RRC reconfiguration complete message. After or in response to receiving the indication or the second CU-to-DU message from the CU, the DU applies the DU configuration to communicate with the UE.

In some implementations, the CU can include the MN restriction information in a CG-ConfigInfo IE and includes the CG-ConfigInfo IE in the first CU-to-DU message and/or the second CU-to-DU message.

In some implementations, the CU receives, from the candidate SN, a CG-Config IE and/or the coordination information in an SN message of the conditional procedure. The CG-Config IE includes the SN restriction information. The CU can include the CG-Config IE in the first CU-to-DU message to transmit the SN restriction information to the DU.

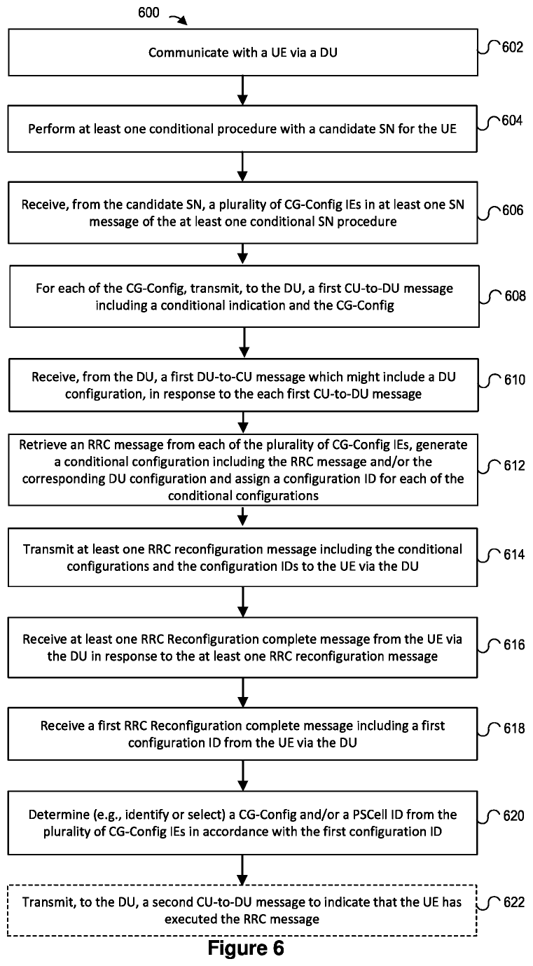

Turning to FIG. 6, a method 600 where an MN-CU (e.g., the CU 172 of the MN 104A), performs a conditional SN procedure with a candidate SN (e.g., the C-SN 106A) for a UE (e.g., the UE 102) is described. The method 600 is similar to the method 500, except that the MN-CU receives a plurality of CG-Config IEs and a plurality of SN restriction information.

The method 600 starts at block 602 where the CU communicates with a UE via a DU. The CU at block 604 performs at least one conditional procedure (e.g., CPA or CPC) with a candidate SN for the UE (e.g., event 304). The CU at block 606 receives, from the candidate SN, a plurality of CG-Config IEs in at least one SN message of the at least one conditional SN procedure (e.g., event 308). At block 608, for each of the CG-Config IE, the CU transmits, to the DU, a first CU-to-DU message including a conditional indication and the CG-Config IE (e.g., event 307). In some implementations, the first CU-to-DU message includes also the CG-ConfigInfo IE. In some implementations, the conditional indication is a Conditional MCG Information IE indicating CPAC-initiation. At block 610, the CU receives, from the DU, a first DU-to-CU message, in response to the each first CU-to-DU message (e.g., event 309). In some implementations, the first DU-to-CU message might include a DU configuration (i.e., an MCG configuration). The CU at block 612 retrieves an RRC message (i.e., SN RRC message) from each of the plurality of CG-Config IEs, generates a conditional configuration including the RRC message and/or the corresponding DU configuration and assign a configuration ID for each of the conditional configurations. In some implementations, the RRC message is or includes a C-SN configuration described above. The CU at block 614 transmits at least one RRC reconfiguration message including the conditional configurations and the configuration IDs to the UE via the DU (e.g., events 310 and 312). In some implementations, if the CU receives the DU configuration at block 610, the CU includes the DU configuration and the SN RRC message in a conditional (re)configuration IE in the RRC Reconfiguration message of block 614. In some implementations, the CU can generate a MN RRC message including the DU configuration and the SN RRC message and include the MN RRC message in the conditional (re)configuration IE. At block 616, the CU receives at least one RRC Reconfiguration complete message from the UE via the DU in response to the at least one RRC reconfiguration message (e.g., events 314 and 316). At block 618, the CU receives a first RRC Reconfiguration complete message including a first configuration ID from the UE via the DU (e.g., events 324 and 326). The CU at block 620 determines (e.g., identifies or selects) a CG-Config and/or a PSCell ID from the plurality of CG-Config IEs in accordance with the first configuration ID. The CU at block 622 might transmit, to the DU, a second CU-to-DU message to indicate that the UE has executed the RRC message (e.g., event 334). In some implementations, the second CU-to-DU message includes the CG-Config and/or C-PSCell ID corresponding to the C-PSCell to which the UE has connected. In some implementations, the second CU-to-DU message includes a conditional execution indication. In other implementations, the second CU-to-DU message includes a RRC Reconfiguration Complete Indicator IE. In some implementations, the second CU-to-DU message includes both the RRC Reconfiguration Complete Indicator IE and the conditional execution indication.

In some implementations, the CU at block 608 can include MN restriction information in a CG-ConfigInfo IE in the first CU-to-DU message.

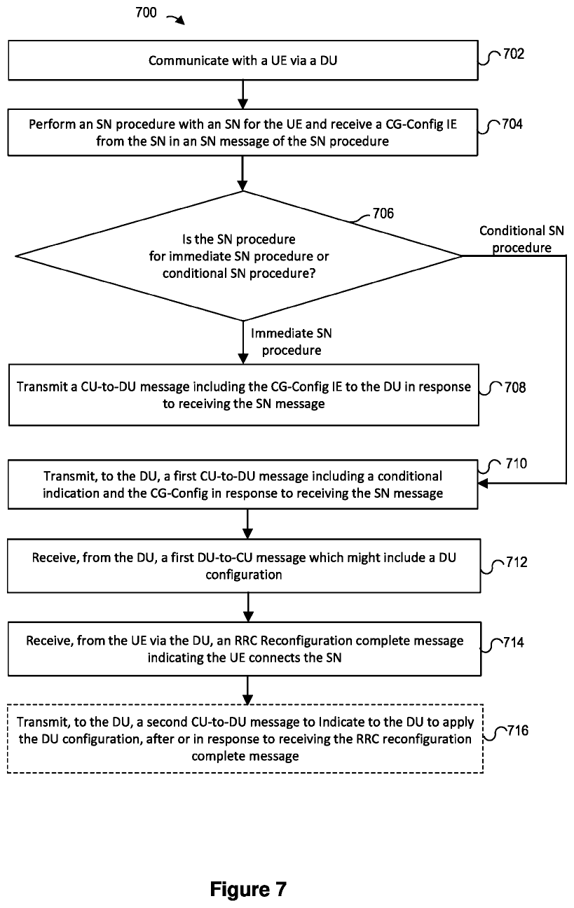

Turning to FIG. 7, a method 700 where an MN-CU (e.g., the CU 172 of the MN 104A), performs a conditional SN procedure with a candidate SN (e.g., the C-SN 106A) for a UE (e.g., the UE 102) is described. During the method 700, the MN-CU determines how to handle the multi-connectivity coordination based on whether an SN procedure is conditional or immediate.

The method 700 starts at block 702 where the CU communicates with a UE via a DU. The CU at block 704 performs an SN procedure (e.g., SN addition procedure or SN modification procedure) with an SN for the UE and receives a CG-Config IE from the SN in an SN message of the SN procedure (e.g., event 308). The CU at block 706 determines whether the SN procedure is for an immediate SN procedure or a conditional SN procedure. If the SN procedure is for an immediate SN procedure, the flow proceeds to block 708 where the CU transmits a CU-to-DU message including the CG-Config IE to the DU in response to receiving the SN message. If the SN procedure is for a conditional SN procedure, the flow proceeds to block 710 where the CU transmits, to the DU, a first CU-to-DU message including a conditional indication and the CG-Config IE in response to receiving the SN message (e.g., event 307). In some implementations, the first CU-to-DU message includes also a CG-ConfigInfo IE for MN restriction information. The flow then proceeds to block 712 where the CU receives, from the DU, a first DU-to-CU message in response to the first CU-to-DU message (e.g., event 309). In some implementations, the first DU-to-CU message might include a DU configuration (i.e., an MCG configuration). In some implementations, the CU retrieves an RRC message (i.e., SN RRC message) from the CG-Config IE. In some implementations, the RRC message is or includes a C-SN configuration described above. If the CU receives the DU configuration at block 712, the CU includes the DU configuration and the SN RRC message in a conditional (re)configuration IE in the RRC Reconfiguration message to the UE (e.g., event 310). In some implementations, the CU can generate a MN RRC message including the DU configuration and the SN RRC message and include the MN RRC message in the conditional (re)configuration IE. The flow continues to block 714 where the CU receives, from the UE via the DU, an RRC Reconfiguration complete message indicating the UE connects the SN (e.g., event 326). In response to or after block 714, the CU at block 716 might transmit, to the DU, a second CU-to-DU message to indicate to the DU to apply the DU configuration, after or in response to receiving the RRC reconfiguration complete message (e.g., event 334).

In some implementations, the second CU-to-DU message includes the CG-Config and/or C-PSCell ID corresponding to the C-PSCell to which the UE has connected. In some implementations, the second CU-to-DU message includes a conditional execution indication. In other implementations, the second CU-to-DU message includes a RRC Reconfiguration Complete Indicator IE. In some implementations, the second CU-to-DU message includes both the RRC Reconfiguration Complete Indicator IE and the conditional execution indication.

Referring next to FIG. 8, a method 800 where a CU (e.g., the CU 172 of the MN 104A), performs a conditional procedure with a candidate DU (e.g., the C-DU 174B) for a UE (e.g., the UE 102) is described. The method 800 is similar to the method 500, except that conditional procedure is performed within the same base station, which operates as both the MN and the C-SN.

The method 800 starts at block 802 where the CU communicates with a UE via a first DU (i.e., an M-DU). The CU at block 804 performs a conditional procedure (e.g., CPA or CPC) with a second DU (i.e., a C-DU) for the UE and receives a DU configuration (i.e., a C-DU configuration) and/or SN restriction information from the second DU in a DU-to-CU message of the procedure (e.g., events 403 and 405). In some implementations, the CU can generate a CG-Config IE including the C-DU configuration and/or SN restriction information. In some implementations, the CU can generate a CG-ConfigInfo IE including the C-DU configuration and/or SN restriction information and/or MN restriction information. The CU at block 806 transmits, to the first DU, a first CU-to-DU message including a conditional indication and a CG-Config IE and/or a CG-ConfigInfo IE corresponding to the C-DU configuration for the UE (e.g., an event similar to 307). The CU at block 808 receives, from the first DU, a first DU-to-CU message in response to the first CU-to-DU message (e.g., an event similar to 309). In some implementations, the first DU-to-CU message might include an M-DU configuration (i.e., an MCG configuration). The CU at block 810 generates an RRC message (e.g., SN RRC message) including the C-DU configuration. At block 812, the CU transmits an RRC reconfiguration message including the RRC message and/or the M-DU configuration to the UE via the first DU (e.g., events 310 and 312, or 494). In some implementations, if the CU receives the M-DU configuration at block 808, the CU includes the M-DU configuration and the SN RRC message in a conditional (re)configuration IE and includes the conditional (re)configuration IE in the RRC Reconfiguration message of block 812. In some implementations, the CU can generate a MN RRC message including the M-DU configuration and the SN RRC message and include the MN RRC message in the conditional (re)configuration IE. The CU at block 814 receives a first RRC reconfiguration complete message from the UE via the DU in response to the RRC reconfiguration message (e.g., events 314 and 316, or 494). The CU at block 816 receives a second RRC Reconfiguration complete message including a configuration ID from the UE via the first DU (e.g., events 324 and 326, or 424 and 426). The flow can then proceed to block 818 where the CU might transmit, to the first DU, a second CU-to-DU Message to indicate that the UE has executed the RRC message, after or in response to receiving the second RRC reconfiguration complete message (e.g., event 434). In some implementations, the second CU-to-DU message includes the CG-Config and/or C-PSCell ID corresponding to the C-PSCell to which the UE has connected. In some implementations, the second CU-to-DU message includes a conditional execution indication. In other implementations, the second CU-to-DU message includes a RRC Reconfiguration Complete Indicator IE. In some implementations, the second CU-to-DU message includes both the RRC Reconfiguration Complete Indicator IE and the conditional execution indication.

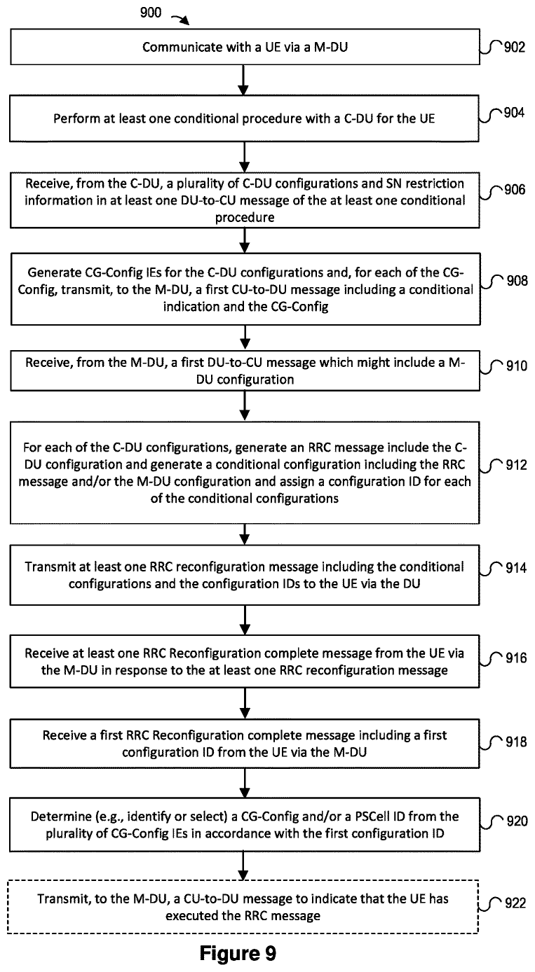

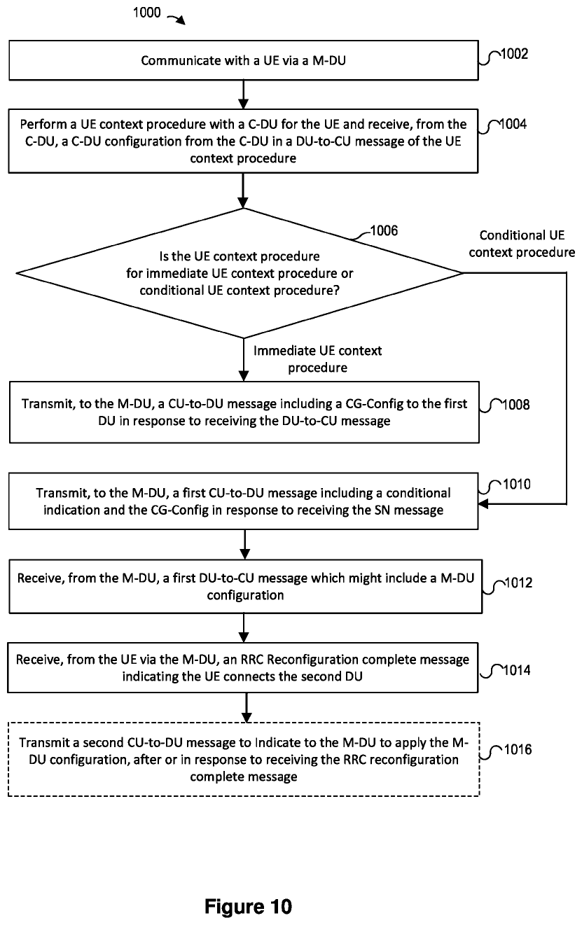

Referring next to FIG. 9, a method 900 where a CU (e.g., the CU 172 of the MN 104A), performs a conditional procedure with a candidate DU (e.g., the C-DU 174B) for a UE (e.g., the UE 102) is described. The method 900 is similar to the method 600, except that conditional procedure is performed within the same base station, which operates as both the MN and the C-SN.

The method 900 starts at block 902 where the CU communicates with a UE via a first DU (i.e., an M-DU). The CU at block 904 performs at least one conditional procedure (e.g., CPA or CPC) with a second DU (i.e., a C-DU) for the UE (e.g., event 403). The CU at block 906 receives, from the second DU, a plurality of C-DU configurations and a plurality of SN restriction information in at least one DU-to-CU message of the at least one conditional procedure (e.g., event 405). At block 908, the CU generates CG-Config IEs for the C-DU configurations and, for each of the CG-Config IE, transmits, to the first DU, a first CU-to-DU message including a conditional indication, the CG-Config IE (e.g., an event similar to 307). In some implementations, for each of the plurality of DU configurations (i.e., C-DU configurations), the CU can generate a CG-Config IE including the C-DU configuration and/or SN restriction information. In some implementations, for each of the plurality of DU configurations (i.e., C-DU configurations), the CU can generate a CG-ConfigInfo IE including the C-DU configuration and/or MN restriction information and include the CG-ConfigInfo in the first CU-to-DU message. At block 910, the CU receives, from the first DU, a first DU-to-CU message in response to the first CU-to-DU message (e.g., an event similar to 309). In some implementations, the first DU-to-CU message might include an M-DU configuration (i.e., an MCG configuration). For each of the plurality of DU configurations, the CU at block 912 generates an RRC message (e.g., SN RRC message) include the C-DU configuration and generates a conditional configuration (e.g., conditional (re)configuration IE) including the RRC message and/or the M-DU configuration and assigns a configuration ID for each of the conditional configurations. If the CU receives the M-DU configuration, the CU might include the M-DU configuration and the SN RRC message in the conditional configuration of block 912. The CU at block 914 transmits at least one RRC reconfiguration message including the conditional configurations and the configuration IDs to the UE via the first DU (e.g., events 310 and 312, or 494). In some implementations, the CU can generate a MN RRC message including the M-DU configuration and the SN RRC message including the C-DU configuration and include the MN RRC message in the conditional configuration of block 914. At block 916, the CU receives at least one RRC reconfiguration complete message from the UE via the first DU in response to the at least one RRC reconfiguration message (e.g., events 314 and 316, or 494). At block 918, the CU receives a first RRC reconfiguration complete message including a first configuration ID from the UE via the first DU (e.g., events 424 and 426). The CU at block 920 determines (e.g., identifies or selects) a CG-Config and/or a PSCell ID from the plurality of CG-Config IEs in accordance with the first configuration ID. In response to or after block 920, the CU might transmit 922, to the first DU, a second CU-to-DU message to indicate that the UE has executed the RRC message (e.g., event 434). In some implementations, the second CU-to-DU message includes the CG-Config and/or C-PSCell ID corresponding to the C-PSCell to which the UE has connected. In some implementations, the second CU-to-DU message includes a conditional execution indication. In other implementations, the second CU-to-DU message includes a RRC Reconfiguration Complete Indicator IE. In some implementations, the second CU-to-DU message includes both the RRC Reconfiguration Complete Indicator IE and the conditional execution indication.

In some implementations, the CU at block 908 can include the CG-ConfigInfo IE in the first CU-to-DU message.

Turning to FIG. 10, a method 1000 where a CU (e.g., the CU 172 of the MN 104A), performs a conditional procedure with a candidate DU (e.g., the C-DU 174B) for a UE (e.g., the UE 102) is described. The method 1000 is similar to the method 700, except that conditional procedure is performed within the same base station, which operates as both the MN and the C-SN.

The method 1000 starts at block 1002 where the CU communicates with a UE via a first DU (i.e., an M-DU). The CU at block 1004 performs a UE context procedure (e.g. UE context setup procedure or UE context modification procedure) with a second DU (i.e., a C-DU) for the UE and receives, from the second DU, a DU configuration from the second DU in a DU-to-CU message of the UE context procedure (e.g., event 405). The CU at block 1006 determines whether the UE context procedure is for an immediate UE context procedure or a conditional UE context procedure. If the UE context procedure is for an immediate UE context procedure, the flow proceeds to block 1008 where the CU transmits, to the first DU, a CU-to-DU message including a CG-Config IE to the first DU in response to receiving the DU-to-CU message. If the UE context procedure is for a conditional UE context procedure, the flow proceeds to block 1010 where the CU transmits, to the first DU, a first CU-to-DU message including a conditional indication and the CG-Config IE and/or CG-ConfigInfo IE in response to receiving the SN message (e.g., an event similar to 307). In some implementations, the CG-Config IE includes the DU configuration (i.e., C-DU configuration). In some implementations, the CG-ConfigInfo IE includes the C-DU configuration. In some implementations, if the UE context procedure is for a conditional UE context procedure, the CU generates a RRC message (e.g., a SN RRC message) including the DU configuration (e.g., a C-DU configuration). At block 1012, the CU receives, from the first DU, a first DU-to-CU message in response to the first CU-to-DU message (e.g., an event similar to 309). In some implementations, the first DU-to-CU message might include an M-DU configuration. If the CU receives the M-DU configuration, the CU includes the M-DU configuration and the SN RRC message in a conditional (re)configuration IE, includes the conditional (re)configuration IE in a RRC reconfiguration message, and transmits the RRC reconfiguration message to the UE via the first DU (e.g., an event similar to 310). In some implementations, the CU can generate a MN RRC message including the first DU configuration and the SN RRC message including the second DU configuration and include the MN RRC message in the conditional (re)configuration IE. At block 1014, the CU receives, from the UE via the first DU, an RRC reconfiguration complete message indicating that the UE connected to the second DU (e.g., events 424 and 426). At block 1016, the CU might transmits, to the first DU, a second CU-to-DU message to indicate to the first DU to apply the M-DU configuration, after or in response to receiving the RRC reconfiguration complete message (e.g., event 434). In some implementations, the second CU-to-DU message includes the CG-Config and/or C-PSCell ID corresponding to the C-PSCell to which the UE has connected. In some implementations, the second CU-to-DU message includes a conditional execution indication. In other implementations, the second CU-to-DU message includes a RRC Reconfiguration Complete Indicator IE. In some implementations, the second CU-to-DU message includes both the RRC Reconfiguration Complete Indicator IE and the conditional execution indication.

Turning to FIG. 11, a method 1100 where a CU (e.g., the CU 172 of the C-MN 104A) receives a conditional handover request from a source MN (e.g., the S-MN 104B) and performs a conditional procedure with a candidate SN (e.g., the C-SN 106A) for a UE (e.g., the UE 102) is described. The method 1100 is similar to the method 500-700, except that the conditional procedure is performed after the CU is requested to prepare a conditional handover.

The method 1100 starts at block 1102 where the CU receives from an S-MN a Handover Request message including a conditional indication (e.g., Conditional Handover Information Request IE indicating CHO-initiation) and a HandoverPreparationInformation IE (e.g., event 382). In some implementations, the Handover Request message also includes a measurement report for the CU to consider for the follow-up SN addition operations. The CU at block 1104 transmits to the DU a UE Context Setup Request message including a conditional indication and the HandoverPreparationInformation IE (e.g., event 342). In some implementations, the conditional indication is a Conditional Inter-DU Mobility Information IE indicating CHO-initiation. The CU at block 1106 receives from the DU a UE Context Setup Response message including a first DU configuration (e.g., event 344). In some implementations, the first DU configuration includes a reconfigurationWithSync IE/field. The CU at block 1108 performs a conditional procedure with a candidate SN for the UE and receive one or more CG-Config IE(s) from the candidate SN in an SN message of the procedure (e.g., event 392). At block 1110, for each of the CG-Config IE(s), the CU transmits, to the DU, a first UE Context Modification Request message including a conditional indication and the CG-Config 1E. In some implementations, the conditional indication is a Conditional MCG Information IE indicating CPAC-initiation. The CU at block 1112 receives, from the DU, a first UE Context Modification Response message. In some implementations, the UE Context Modification Response message might include a second DU configuration. In some implementations, the second DU configuration does not include a reconfigurationWithSync IE/field. The CU at block 1114 generates an RRC reconfiguration message including the first DU configuration and a list of conditional configuration(s) which includes a C-SN configuration and a second DU configuration, if received from the DU in the UE Context Modification Response message. At block 1116, the CU transmits, to the S-MN, a Handover Request Acknowledge message including the RRC reconfiguration message (e.g., event 384). At block 1118, the CU receives a first RRC reconfiguration complete message from the UE via the DU in response to the RRC reconfiguration message. The CU at block 1120 receives a second RRC Reconfiguration complete message including a configuration ID from the UE via the DU. The CU at block 1122 might transmit, to the DU, a second UE Context Modification Request message to indicate that the UE has executed the a C-SN configuration identified by the configuration ID (e.g., event 334). In some implementations, the second UE Context Modification Request message includes the CG-Config and/or C-PSCell ID corresponding to the C-PSCell to which the UE has connected. In some implementations, the second UE Context Modification Request message includes a conditional execution indication. In other implementations, the second UE Context Modification Request message includes a RRC Reconfiguration Complete Indicator IE. In some implementations, the second UE Context Modification Request message includes both the RRC Reconfiguration Complete Indicator IE and the conditional execution indication.

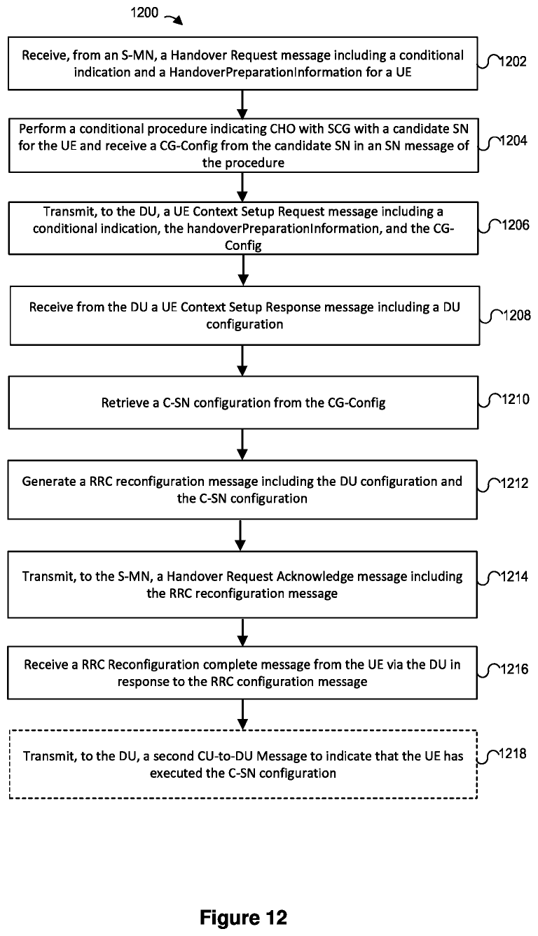

Turning to FIG. 12, a method 1200 where a CU (e.g., the CU 172 of the C-MN 104A) receives a conditional handover request from a source MN (e.g., the S-MN 104B) and performs a conditional procedure with a candidate SN (e.g., the C-SN 106A) for a UE (e.g., the UE 102) is described. The method 1200 is similar to the method 500-700 and 1100, except that the conditional procedure is performed after the CU is requested to prepare a conditional handover and the conditional procedure only acquires one C-SN configuration which will be applied together with the configuration for handover.

The method 1200 starts at block 1202 where the CU receives from an S-MN a Handover Request message including a conditional indication (e.g., Conditional Handover Information Request IE indicating CHO-initiation) and a HandoverPreparationInformation IE for a UE (e.g., event 382). In some implementations, the Handover Request message also includes a measurement report for the CU to consider for the following SN addition operations. The CU at block 1204 performs a conditional procedure indicating CHO with SCG with a candidate SN for the UE and receives a CG-Config IE from the candidate SN in an SN message of the procedure (e.g., events 303 and 305). In some implementations, the CHO with SCG indication is the CHO Information SN Addition IE included in the SN Addition Request message. The CU at block 1206 transmits to the DU a UE Context Setup Request message including a conditional indication, the HandoverPreparationInformation IE, and the CG-Config IE (e.g., event 341). In some implementations, the conditional indication may include a Conditional Inter-DU Mobility Information IE indicating CHO-initiation and/or a Conditional MCG Information IE indicating CPAC-initiation. The CU at block 1208 receives from the DU a UE Context Setup Response message including a DU configuration (e.g., event 343). In some implementations, the DU configuration includes a reconfigurationWithSync IE/field. In some implementations, the DU generates the DU configuration based on the received HandoverPreparationInformation IE, the CG-Config IE, and/or the CG-ConfigInfo IE. The CU at block 1210 retrieve a C-SN configuration from the CG-Config IE. At block 1212, the CU generates an RRC reconfiguration message including the DU configuration and the C-SN configuration. At block 1214, the CU transmits, to the S-MN, a Handover Request Acknowledge message including the RRC reconfiguration message (e.g., event 385). At block 1216, the CU receives an RRC reconfiguration complete message from the UE via the DU in response to the RRC reconfiguration message. The CU at block 1218 transmits, to the DU, a UE Context Modification Request message to indicate that the UE has executed the C-SN configuration (e.g., event 335). In some implementations, the UE Context Modification Request message does not include the CG-Config and/or C-PSCell ID corresponding to the C-PSCell to which the UE has connected since there was only C-PSCell prepared. In some implementations, the UE Context Modification Request message includes a conditional execution indication. In other implementations, the second UE Context Modification Request message includes a RRC Reconfiguration Complete Indicator IE. In some implementations, the second UE Context Modification Request message includes both the RRC Reconfiguration Complete Indicator IE and the conditional execution indication.

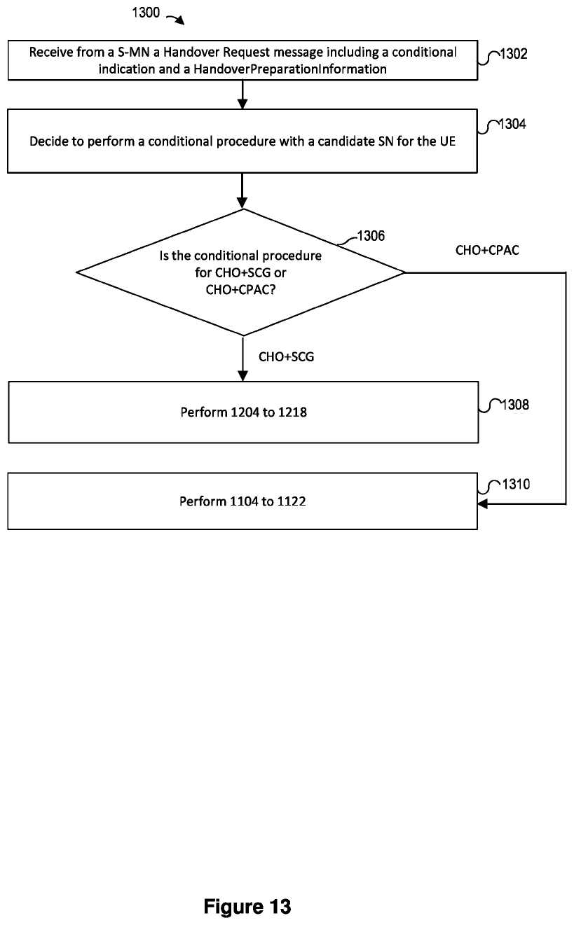

Referring next to FIG. 13, FIG. 13 illustrates a method 1300 for managing a conditional handover request and multi-connectivity information, which can be implemented in a CU (e.g., the CU 172) of a distributed base station (e.g., the candidate master base station 104A) including the CU and a DU (e.g., the DU 174).

At block 1302, the CU receives from an S-MN a Handover Request message including a conditional indication and a HandoverPreparationInformation IE (e.g., event 382). At block 1304, the CU decides to perform a conditional procedure with a candidate SN for the UE. At block 1306, the CU determines whether the conditional procedure is for CHO with SCG or CHO with CPAC. In some implementations, the CU makes the determination based on the measurement reports and/or other assistance information received in the Handover Request message or pre-configuration at the CU. If the CU decides to perform CHO with SCG, the flow proceeds to block 1308 where the CU performs blocks 1204 to 1218 as described in FIG. 12. Alternatively, if the CU decides to perform CHO with CPAC, the flow proceeds to block 1310 where the CU performs blocks 1104 to 1122 as described in FIG. 11.

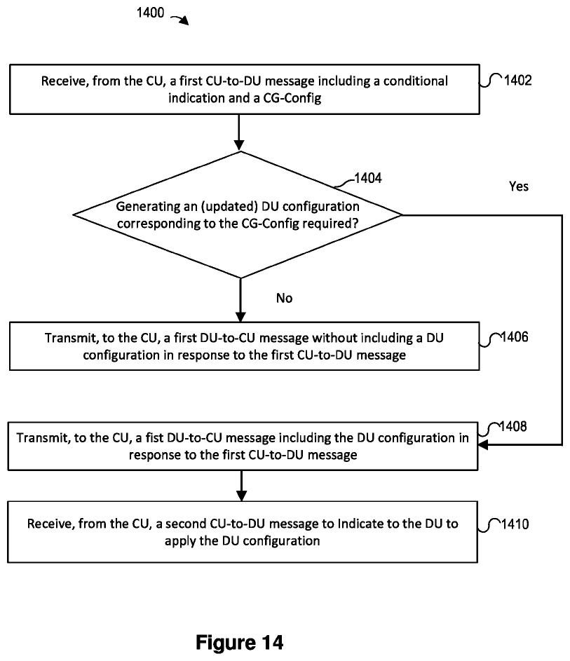

Referring next to FIG. 14, FIG. 14 illustrates a method 1400 for managing multi-connectivity information, which can be implemented in a DU (e.g., the DU 174) of a distributed base station (e.g., the candidate master base station 104A) including a CU (e.g., the CU 172) and the DU.

At block 1402, the DU receives from the CU, a first CU-to-DU message including a conditional indication and a CG-Config IE and/or a CG-ConfigInfo IE (e.g., event 307). In some implementations, the first CU-to-DU message is a UE Context Modification Request message. In some implementations, the conditional indication is a Conditional MCG Information IE indicating CPAC-initiation. At block 1404, the DU decides whether it needs to generate a (updated) DU configuration corresponding to the CG-Config IE. In some implementations, the DU makes the determination by checking whether simultaneously applying the original DU configuration and the C-SN configuration exceed capabilities of the UE; if the UE capabilities is exceeded, an updated DU configuration is necessary. If the DU decides not generate a (updated) DU configuration, the flow proceeds to block 1406 where the DU transmits, to the CU, a fist DU-to-CU message without including a (updated) DU configuration in response to the first CU-to-DU message (e.g., event 309). Alternatively, if the DU decides to generate a (updated) DU configuration, the flow proceeds to block 1408 where the DU transmits, to the CU, a fist DU-to-CU message including the (updated) DU configuration in response to the first CU-to-DU message (e.g., event 309). The DU at block 1410 receives, from the CU, a second CU-to-DU message to indicate to the DU to apply the DU configuration (e.g., event 334). In some implementations, the second CU-to-DU message include the CG-Config and/or C-PSCell ID corresponding to the C-PSCell to which the UE has connected. In some implementations, the CU-to-DU message includes a conditional execution indication. In other implementations, the second CU-to-DU message includes a RRC Reconfiguration Complete Indicator IE. In some implementations, the second CU-to-DU message includes both the RRC Reconfiguration Complete Indicator IE and the conditional execution indication. In some implementations, the second CU-to-DU message is a UE Context Modification Request message.

Referring generally to the scenarios above, for (immediate) DC operation, the MN (e.g., the MN 104A) may reconfigure/update the MCG configuration based on the SCG configuration/information, and the CU can include a CG-Config IE in the CU-to-DU RRC Information for lower layer parameter coordination in a disaggregated MN. For CPAC, the MN can send to the UE an RRC reconfiguration message including a list of RRC reconfiguration messages including both MCG and SCG configuration (e.g., RRC reconfiguration), for application together upon CPAC execution.

Because it was unclear how a disaggregated MN generates the conditional RRC reconfiguration message including MCG configuration for CPAC, or how the MN gNB-DU can determine that a UE selected a candidate PSCell and that the corresponding MCG L1/L2 configuration will apply, or how the MN-DU can obtain the MN restriction information, a network of this disclosure adds a conditional indicator, in particular a Conditional MCG Information IE, in the UE context modification request procedure for MN purposes in CPAC. The gNB-CU provides the CG-Config IE and/or CG-ConfigInfo IE corresponding to the candidate PSCell to the gNB-DU and obtains MCG configuration upon CPAC initiation. Further, the gNB-CU provides the CG-Config IE corresponding to the selected candidate PSCell to the gNB-DU, and the gNB-DU applies the MCG configuration upon CPAC execution. The CU can include the conditional indicator in a UE Context Modification Request message.

More particularly, the MN-CU (e.g., the CU 172) can include a Conditional MCG Information IE in the UE CONTEXT MODIFICATION REQUEST message and set the CPAC Trigger indicator “CPAC-initiation” and set the UE CONTEXT MODIFICATION REQUEST message to the gNB-DU, which can operate as an MN-DU (e.g., the DU 174). If the MN-DU supports CPAC, the gNB-DU considers that the request concerns a conditional PSCell addition or conditional PSCell change, accounts for the CG-Config IE and/or CG-ConfigInfo IE included in the UE CONTEXT MODIFICATION REQUEST message, and provides the corresponding CellGroupConfig IE to the gNB-CU for MCG configuration preparation in the UE CONTEXT MODIFICATION RESPONSE message.

On the other hand, if the MN-CU includes, in the UE CONTEXT MODIFICATION REQUEST message, the Conditional MCG Information IE along with the CPAC Trigger set to “CPAC-execution”, and if the gNB-DU supports CPAC, the gNB-DU considers that, for the CG-Config IE included in the UE CONTEXT MODIFICATION REQUEST message and corresponding to the selected PSCell, the UE has successfully executed the CPAC preparation. The gNB-DU then can apply the corresponding CellGroupConfig IE for MCG configuration at the gNB-DU. If the UE CONTEXT MODIFICATION REQUEST message includes a Conditional Intra-DU Mobility Information IE, and the CHO Trigger is set to “CHO-initiation”, the gNB-DU considers that the request concerns a conditional handover or conditional PSCell addition or conditional PSCell change for the included SpCell ID IE, and include the SpCell as the Requested Target Cell ID IE in the UE CONTEXT MODIFICATION RESPONSE message. The gNB-DU regards this UE CONTEXT MODIFICATION REQUEST message as including a reconfiguration with sync.

The definition of the UE CONTEXT MODIFICATION REQUEST message can include, in additional to the elements listed in prior versions of TS 38.473, a ConditionalMCGInformation field, for example:

```
UEContextModificationRequest ::= SEQUENCE {
protocolIEs ProtocolIE-Container
{ { UEContextModificationRequestIEs} },
. . .
}
UEContextModificationRequestIEs F1AP-PROTOCOL-IES ::= {
. . .
    { ID id-ConditionalMCGInformation
            CRITICALITY ignore
            TYPE ConditionalMCGInformation
            PRESENCE optional } . . .
    }, . . .
}
```

The definitions of IEs can include the following example definition:

```
ConditionalMCGInformation ::= SEQUENCE {
    cpac-trigger CPAC-trigger,
    pscellid NRCGI,
    iE-Extensions ProtocolExtensionContainer
    { { ConditionalIntraDUMobility Information-ExtIEs} } OPTIONAL,
    . . .
}
CPAC-trigger ::= ENUMERATED {
    cpac-initiation,
    cpac-execution,
    . . .
}
```

The disclosure contemplates at least the following examples:
Example 1. A method for managing conditional cell change in a central unit (CU) of a distributed base station that includes the CU and a distributed unit (DU), the method comprising: obtaining, by the CU, a cell group (CG) configuration for one or more candidate secondary cells of a candidate secondary node (SN) to support dual connectivity (DC) between a UE, the DU operating as a master node (MN), and the candidate SN; transmitting, from the CU to the DU, the CG configuration; receiving, from at the CU from the DU, a DU configuration corresponding to the CG configuration; and transmitting, from the CU to the UE via the DU, (i) a conditional SN configuration corresponding to the CG configuration, (ii) at least one condition to be satisfied prior to the UE initiating a procedure to connect to the candidate node according to the conditional SN configuration, and (iii) the DU configuration.
Example 2. The method of example 1, wherein the obtaining of the CG configuration includes receiving the CG configuration from the candidate SN, the CU and the candidate node implemented in different base stations.
Example 3. The method of example 1, wherein the obtaining of the CG configuration includes generating the CG configuration at the CU, the candidate SN implemented in a second DU of the distributed base station.
Example 4. The method of any of the preceding examples, wherein the transmitting of the CG configuration to the DU includes transmitting a single CU-to-DU message including a list of two or more elements, each of the elements corresponding to a different respective candidate secondary cell.
Example 5. The method of any of examples 1-3, wherein the transmitting of the CG configuration to the DU includes transmitting a plurality of CU-to-DU messages, each of the CU-to-DU messages information corresponding to a different respective candidate secondary cell.
Example 6. The method of example 4 or 5, wherein each CU-to-DU message is a is UE Context Modification Request message.
Example 7. The method of any of the preceding examples, further comprising, subsequently to the transmitting of the SN configuration to the UE: receiving, from the UE via the DU, an indication that the UE has completed a reconfiguration of the radio link according to the DU configuration; and transmitting, to the DU, an indication that the UE has completed the reconfiguration.
Example 8. The method of example 7, wherein: the transmitting of the SN configuration to the UE includes transmitting a configuration identifier; and the receiving of the indication from the UE includes receiving the configuration identifier.
Example 9. The method of any of the preceding examples, wherein obtaining the CG configuration includes obtaining SN restriction information.
Example 10. The method of example 9, further comprising: transmitting, from the CU to the DU, the SN restriction information.
Example 11. A base station comprising processing hardware and configured to implement a method according to any of the preceding examples.

The following description may be applied to the description above.

Generally speaking. description for one of the above figures can apply to another of the above figures. Examples, implementations and methods described above can be combined, if there is no conflict. An event or block described above can be optional or omitted. For example, an event or block with dashed lines in the figures can be optional. In some implementations, “message” is used and can be replaced by “information element (IE)”. In some implementations, “IE” is used and can be replaced by “field”. In some implementations, “configuration” can be replaced by “configurations” or the configuration parameters.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A configuration method implemented in a central unit (CU) of a distributed master node (MN) that also includes a distributed unit (DU), the method comprising:
transmitting, to the DU, a context modification request for a UE, the context modification request including a conditional execution indication that the context modification request pertains to a conditional addition or change of a primary secondary cell (PSCell), the conditional execution indication including a trigger value indicating whether the UE executed a preparation for the conditional addition or change; and
receiving, from the DU, a context modification response for the UE.

2. The method of claim 1, wherein:
the trigger value indicates that the preparation for the conditional addition or change of the PSCell has not been executed, and
the context modification response includes a cell group configuration information.

3. The method of claim 2, wherein the cell group configuration information is CG-ConfigInfo information element (IE).

4. The method of claim 2, further comprising:
using the cell group configuration information in master cell group (MCG) configuration preparation.

5. The method of claim 2, wherein:
the context modification request includes a PSCell identifier; and
the context modification response includes a requested target cell identifier corresponding to the PSCell identifier.

6. The method of claim 1, wherein:
the conditional execution indication indicates that the conditional addition or change of the PSCell has been executed, and
the context modification request includes a PSCell identifier identifying a selected PSCell.

7. The method of claim 1, further comprising:
transmitting, to the UE via the DU, a radio resource control (RRC) reconfiguration message including a master cell group (MCG) configuration and a secondary cell group (SCG) configuration.

8. The method of claim 1, wherein
the context modification request is included in a CU-to-DU message, and wherein the CU-to-DU message includes MN restriction information.

9. A configuration method implemented in a distributed unit (DU) of a distributed master node (MN) that also includes a central unit (CU), the method comprising:
receiving, from the CU, a context modification request for a UE, the context modification request including a conditional execution indication that the context modification request pertains to a conditional addition or change of a primary secondary cell (PSCell), the conditional execution indication including a trigger value indicating whether the UE executed a preparation for conditional addition or change.

10. The method of claim 9, further comprising:
when the trigger value indicates that the preparation has not been executed:
generating a CellGroupConfig information element (IE) for master cell group (MCG) preparation, using a CG-Config IE included in the context modification request, and
transmitting the CellGroupConfig IE to the CU in a context modification response.

11. The method of claim 10, wherein:
the context modification request includes a PSCell identifier; and
the context modification response includes a requested target cell identifier corresponding to the PSCell identifier.

12. The method of claim 9, further comprising:
when the trigger value indicates that the preparation has been executed:
determining that the UE has successfully executed the preparation for a cell identified by a PSCell identifier included in the context modification request.

13. The method of claim 12, further comprising:
applying a cell group configuration corresponding to the identified cell, for MCG configuration.

14. The method of claim 9, wherein the context modification request is included in a CU-to-DU message, and wherein the CU-to-DU message includes MN restriction information.

15. A central unit (CU) of a master node (MN), comprising:
a transceiver; and
processing hardware configured to:
transmit, to a distributed unit (DU) of the MN, a context modification request for a user equipment (UE), the context modification request including a conditional execution indication that the context modification request pertains to a conditional addition or change of a primary secondary cell (PSCell), the conditional execution indication including a trigger value indicating whether the UE executed a preparation for the conditional addition or change; and
receive, from the DU, a context modification response for the UE.

16. The CU of claim 15, wherein:
the trigger value indicates that the preparation for the conditional addition or change of the PSCell has not been executed, and
the context modification response includes a cell group configuration information, wherein the cell group configuration information is CG-ConfigInfo information element (IE).

17. The CU of claim 16, wherein the processing hardware is further configured to use the cell group configuration information in master cell group (MCG) configuration preparation.

18. The CU of claim 16, wherein:
the context modification request includes a PSCell identifier; and
the context modification response includes a requested target cell identifier corresponding to the PSCell identifier.

19. The CU of claim 15, wherein:
the conditional execution indication indicates that the conditional addition or change of the PSCell has been executed, and
the context modification request includes a PSCell identifier identifying a selected PSCell.

20. The CU of claim 15, wherein:
the processing hardware is further configured to transmit, to the UE via the DU, a radio resource control (RRC) reconfiguration message including a master cell group (MCG) configuration and a secondary cell group (SCG) configuration, and
the context modification request is included in a CU-to-DU message, and wherein the CU-to-DU message includes MN restriction information.
